(19) United States
(12) Patent Application Publication
(10) Pub. No.: US 2022/0084294 A1
(43) Pub. Date: Mar. 17, 2022

(54) ENHANCED ARTIFICIAL REALITY SYSTEMS

(71) Applicant: Facebook Technologies, LLC, Menlo Park, CA (US)

(72) Inventors: Hao Chen, Kirkland, WA (US); Luc Oth, Zurich (CH); Christian Forster, Zofingen (CH); Alejo Concha Belenguer, Zurich (CH); Jesús Briales, Adliswil (CH); Hideo Tamama, Kirkland, WA (US); Juan Manuel Martinez, Redmond, WA (US)

(21) Appl. No.: 17/475,155

(22) Filed: Sep. 14, 2021

Related U.S. Application Data
(60) Provisional application No. 63/078,811, filed on Sep. 15, 2020.
(60) Provisional application No. 63/078,818, filed on Sep. 15, 2020.
(60) Provisional application No. 63/108,821, filed on Nov. 2, 2020.
(60) Provisional application No. 63/172,001, filed on Apr. 7, 2021.
(60) Provisional application No. 63/213,063, filed on Jun. 21, 2021.

(51) Int. Cl. G06T 19/00; G06T 3/40; G06T 3/20; G06F 3/14; G02B 27/01

(52) U.S. Cl. CPC G06T 19/006; G06T 3/4053; G06T 3/20; G02B 2027/014; G02B 27/0172; G02B 2027/0178; G02B 2027/0138; G06F 3/14

(57) ABSTRACT

One embodiment is directed to controlling a user device based on an interpreted user intention. Another embodiment is directed to generating a three-dimensional first-resolution digital map of a geographic area in real world based on second-resolution observations on the geographic area using a machine-learning model, where the first resolution is higher than the second resolution. Another embodiment is directed to estimating a location and/or a pose of a camera with images captured by the camera and data from Inertial Measurement Unit (IMU) sensors. Another embodiment is directed to causing the content of an app running on a first device to be rendered by and displayed on a second device. Yet another embodiment is directed to an augmented reality device comprising a pair of glasses and a hat.

### PRIORITY

This application claims the benefit under 35 U.S.C. § 119(e) of U.S. Provisional Patent Application No. 63/078,811, filed 15 Sep. 2020, U.S. Provisional Patent Application No. 63/078,818, filed 15 Sep. 2020, U.S. Provisional Patent Application No. 63/108,821, filed 2 Nov. 2020, U.S. Provisional Patent Application No. 63/172,001, filed 7 Apr. 2021, and U.S. Provisional Patent Application No. 63/213,063, filed 21 Jun. 2021, which are incorporated herein by reference.

### TECHNICAL FIELD

This disclosure generally relates to artificial-reality systems.

### BRIEF DESCRIPTION OF THE DRAWINGS

FIG. 1A illustrates an example artificial reality system.

FIG. 1B illustrates an example augmented reality system.

FIG. 2 illustrates an example communication framework for controlling a user device based on an interpreted user intention.

FIG. 3 illustrates an example logical architecture of a computing device that controls a user device based on an interpreted user intention.

FIG. 4 illustrates an example scenario where a computing device controls a power wheelchair based on an interpreted user intention.

FIG. 5 illustrates an example method for controlling a user device based on an interpreted user intention.

FIG. 6 illustrates an example system for generating high-resolution scenes based on low-resolution observations using a machine-learning model.

FIG. 7A illustrates an example system for training an auto-encoder generative continuous model.

FIG. 7B illustrates an example system for training an auto-decoder generative continuous model.

FIG. 8 illustrates an example method for generating high-resolution scenes based on low-resolution observations using a machine-learning model.

FIG. 9A illustrates an example method for training an auto-encoder generative continuous model.

FIG. 9B illustrates an example method for training an auto-decoder generative continuous model.

FIG. 10 illustrates an example logical architecture of First Frame Tracker (FFT).

FIG. 11 illustrates an example logical architecture of First Frame Pose Estimator.

FIG. 12 illustrates an example method for estimating a pose of a camera without initializing SLAM.

FIG. 13 illustrates an example system block diagram for generating and distributing rendering instructions between two connected devices.

FIG. 14 illustrates an example process for generating and distributing rendering instructions from one device to another.

FIGS. 15A-15B illustrate an example wearable ubiquitous AR system.

FIG. 16A illustrates various components of the wearable ubiquitous AR system.

FIGS. 16B-16D illustrate different views of the wearable ubiquitous AR system.

FIG. 17 illustrates an example computer system.

### DESCRIPTION OF EXAMPLE EMBODIMENTS

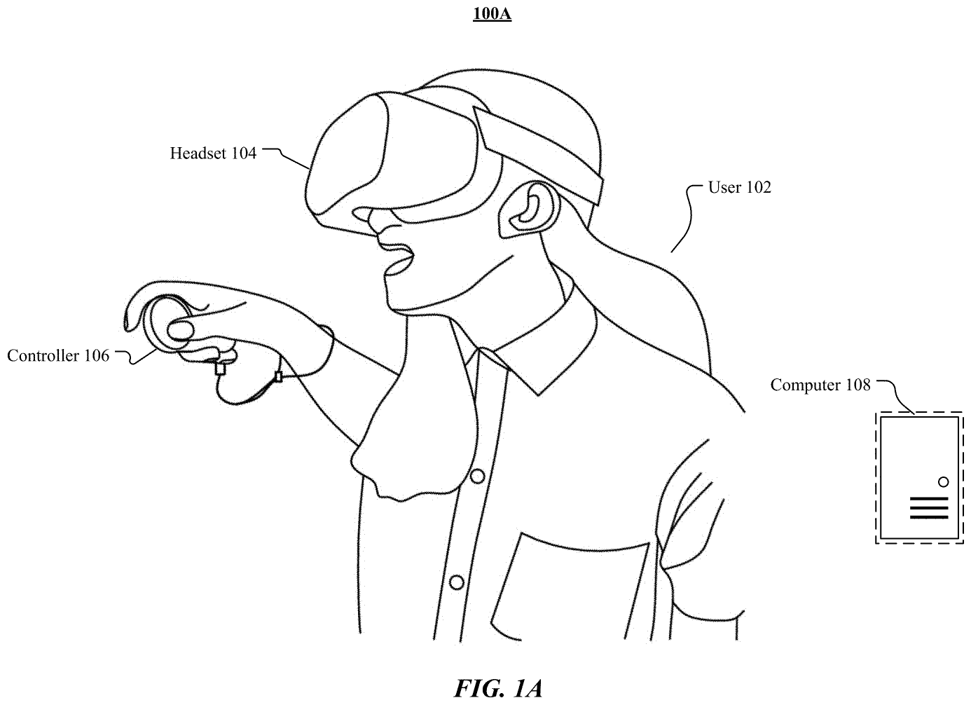

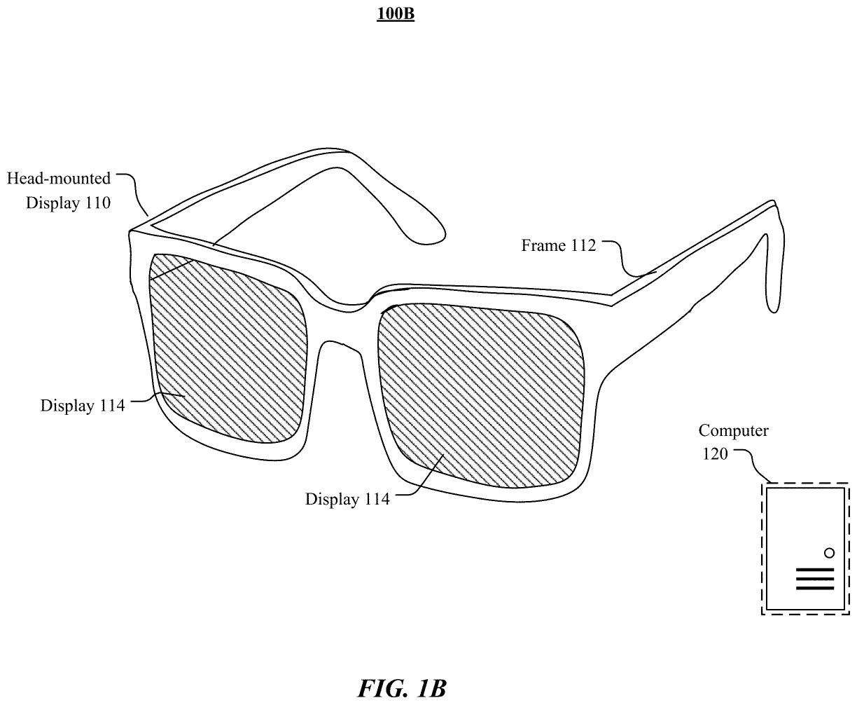

FIG. 1A illustrates an example artificial reality system 100A. In particular embodiments, the artificial reality system 100A may comprise a headset 104, a controller 106, and a computing system 108. A user 102 may wear the headset 104 that may display visual artificial reality content to the user 102. The headset 104 may include an audio device that may provide audio artificial reality content to the user 102. The headset 104 may include one or more cameras which can capture images and videos of environments. The headset 104 may include an eye tracking system to determine the vergence distance of the user 102. The headset 104 may include a microphone to capture voice input from the user 102. The headset 104 may be referred as a head-mounted display (HDM). The controller 106 may comprise a trackpad and one or more buttons. The controller 106 may receive inputs from the user 102 and relay the inputs to the computing device 108. The controller 106 may also provide haptic feedback to the user 102. The computing device 108 may be connected to the headset 104 and the controller 106 through cables or wireless connections. The computing device 108 may control the headset 104 and the controller 106 to provide the artificial reality content to and receive inputs from the user 102. The computing device 108 may be a standalone host computing device, an on-board computing device integrated with the headset 104, a mobile device, or any other hardware platform capable of providing artificial reality content to and receiving inputs from the user 102.

FIG. 1B illustrates an example augmented reality system 100B. The augmented reality system 100B may include a head-mounted display (HMD) 110 (e.g., glasses) comprising a frame 112, one or more displays 114, and a computing device 120. The displays 114 may be transparent or translucent allowing a user wearing the HMD 110 to look through the displays 114 to see the real world and displaying visual artificial reality content to the user at the same time. The HMD 110 may include an audio device that may provide audio artificial reality content to users. The HMD 110 may include one or more cameras which can capture images and videos of environments. The HMD 110 may include an eye tracking system to track the vergence movement of the user wearing the HMD 110. The HMD 110 may include a microphone to capture voice input from the user. The augmented reality system 100B may further include a controller comprising a trackpad and one or more buttons. The controller may receive inputs from users and relay the inputs to the computing device 120. The controller may also provide haptic feedback to users. The computing device 120 may be connected to the HMD 110 and the controller through cables or wireless connections. The computing device 120 may control the HMD 110 and the controller to provide the augmented reality content to and receive inputs from users. The computing device 120 may be a standalone host computer device, an on-board computer device integrated with the HMD 110, a mobile device, or any other hardware platform capable of providing artificial reality content to and receiving inputs from users.

### Autonomous Enablement

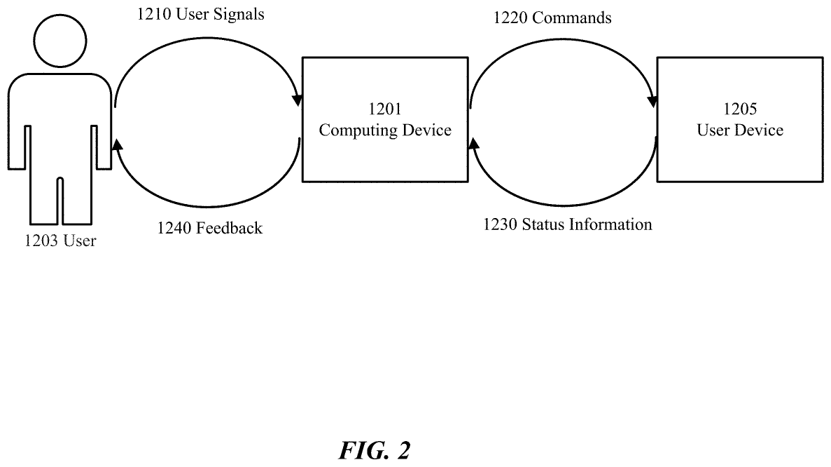

FIG. 2 illustrates an example communication framework for controlling a user device based on an interpreted user intention. In particular embodiments, a computing device 1201 may be an artificial reality system 1100A. In particular embodiments, the computing device 1201 may be an augmented reality system 1100B. In particular embodiments, the computing device 1201 may be any suitable computing device that has one or more interfaces towards a user 1203 and has one or more communication links towards a user device 1205. The computing device 1201 may receive user signals 1210 from the user 1203 and provide feedback 1240 to the user via the one or more interfaces towards the user 1203. The one or more interfaces towards the user 1203 may comprise, for example but not limited to, a microphone, an eye tracking device, a BCI, a gesture detection device, or any suitable human-computer interfaces. The computing device 1201 may send commands 1220 to the user device 1205 and receive status information 1230 from the user device 1205 through the one or more communication links. Although this disclosure describes a particular communication framework for a computing device that controls a user device based on an interpreted user intention, this disclosure contemplates any suitable communication framework for a computing device that controls a user device based on an interpreted user intention.

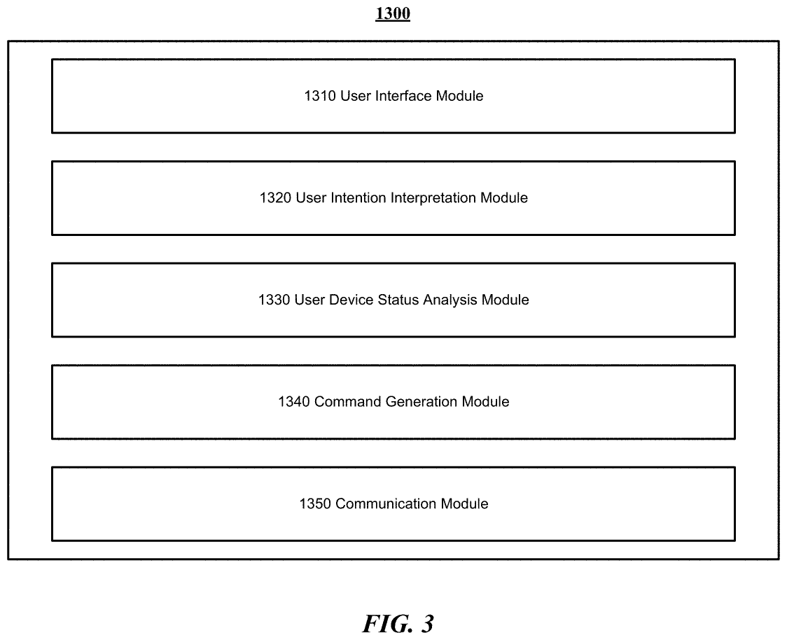

FIG. 3 illustrates an example logical architecture 1300 of a computing device that controls a user device based on an interpreted user intention. A user interface module 1310 may receive signals from the user 1203. The user interface module 1310 may also provide feedback to the user 1203. The user interface module 1310 may be associated with, for example but not limited to, a microphone, an eye tracking device, a BCI, a gesture detection device, or any suitable human-computer interfaces. A user intention interpretation module 1320 may determine a user intention based on the received signals received by the user interface module 1310. The user intention interpretation module 1320 may analyze the received user signals and may determine the user intention based on data that maps the user signals to the user intention. In particular embodiments, the user intention interpretation module 1320 may use a machine-learning model for determining the user intention. A user device status analysis module 1330 may analyze status information received from the user device 1205. The user device status analysis module 1330 may determine current environment surrounding the user device 1205 and current state of the user device 1205. A command generation module 1240 may generate one or more commands for the user device 1205 to execute based on the user intention determined by the user intention interpretation module 1320 and the current environment surrounding the user device 1205 and the current state of the user device 1205 determined by the user device status analysis module 1330. A communication module 1350 may send a subset of the one or more commands generated by the command generation module 1340 to the user device 1205. The communication module 1350 may also receive status information from the user device 1205 and forward the received status information to the user device status analysis module 1330. Although this disclosure describes a particular logical architecture of a computing device that controls a user device based on an interpreted user intention, this disclosure contemplates any suitable logical architecture of a computing device that controls a user device based on an interpreted user intention.

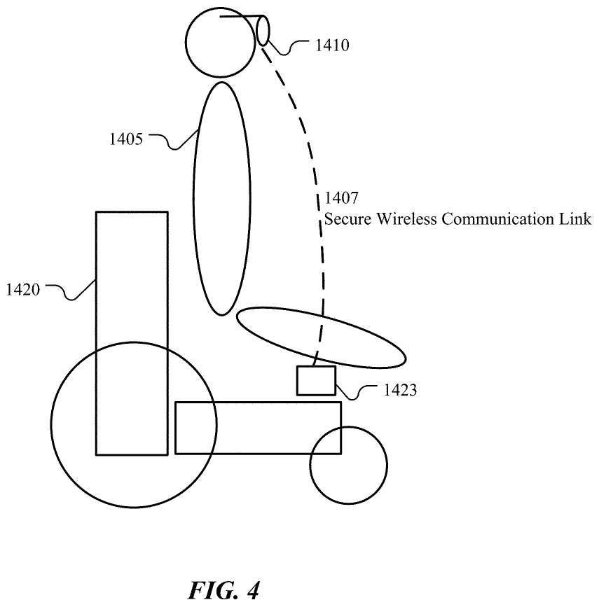

In particular embodiments, the computing device 1201 may be associated with a user 1203. In particular embodiments, the computing device may be associated with a wearable device such as an HMD 1104, or an augmented-reality glasses 1110. In particular embodiments, the computing device 1201 may be any suitable computing device that has one or more interfaces towards a user 1203 and has one or more communication links towards a user device 1205. FIG. 4 illustrates an example scenario where a computing device controls a power wheelchair based on an interpreted user intention. As an example and not by way of limitation, illustrated in FIG. 4, a pair of wearable augmented-reality glasses 1410 is associated with a user 1405. The augmented-reality glasses 1410 may have established a secure wireless communication link 1407 with a power wheelchair 1420. The power wheelchair 1420 may comprise a wireless communication interface 1423 and an integrated processing unit (not shown in FIG. 4). Although this disclosure describes a particular computing device that controls a user device based on an interpreted user intention, this disclosure contemplates a particular computing device that controls a user device based on an interpreted user intention.

In particular embodiments, the computing device 1201 may receive user signals from the user 1203. In particular embodiments, the user signals may comprise voice signals of the user 1203. The voice signals may be received through a microphone associated with the computing device 1201. In particular embodiments, the user signals may comprise a point of gaze of the user 1203. The point of gaze of the user 1203 may be sensed by an eye tracking module associated with the computing device 1201. In particular embodiments, the user signals may comprise brainwave signals sensed by a brain-computer interface (BCI) associated with the computing device 1201. In particular embodiments, the user signals may comprise any suitable combination of user input that may comprise voice, gaze, gesture, brainwave or any suitable user input that is detectable by the computing device. As an example and not by way of limitation, continuing with a prior example illustrated in FIG. 4, the augmented-reality glasses 1410 may receive a voice command “go to the convenience store across the street” from the user 1405. The user interface module 1310 of the augmented-reality glasses 1410 may receive the voice command via a microphone associated with the augmented-reality glasses 1410. As another example and not by way of limitation, the user 1410 may look at the convenience store across the store. The user interface module 1310 of the augmented-reality glasses 1410 may detect that the user is looking at the convenience store across the store through an eye tracking device associated with the augmented-reality glasses 1410. As yet another example and not by way of limitation, the augmented-reality glasses 1410 may receive brainwave signals from the user 1405 indicating that the user wants to go to the convenience store across the street. The user interface module 1310 of the augmented-reality glasses 1410 may receive the brainwave signals through a BCI associated with the augmented-reality glasses 1410. Although this disclosure describes receiving user signals in a particular manner, this disclosure contemplates receiving user signals in any suitable manner.

In particular embodiments, the computing device 1201 may determine a user intention based on the received user signals. In order to detect the user intention, the computing device 1201 may first analyze the received user signals and then may determine the user intention based on data that maps the user signals to the user intention. In particular embodiments, the computing device may use a machine-learning model for determining the user intention. As an example and not by way of limitation, continuing with a prior example illustrated in FIG. 4, the user intention interpretation module 1320 of the augmented-reality glasses 1410 may determine that the user 1405 wants to go to the convenience store across the street by analyzing the voice command. The user intention interpretation module 1320 may utilize a natural language processing machine-learning model to determine the user intention based on the voice command from the user 1405. As another example and not by way of limitation, the user intention interpretation module 1320 of the augmented-reality glasses 1410 may determine that the user 1405 wants to go to the convenience store across the street based on a fact that the user 1405 is looking at the convenience store. In particular embodiments, the augmented-reality glasses 1410 may get a confirmation on the user intention from the user 1405 by asking the user 1405 whether user 1405 wants to go to the convenience store. As yet example and not by way of limitation, the user intention interpretation module 1320 of the augmented-reality glasses 1410 may determine that the user 1405 wants to go to the convenience store across the street by analyzing the brainwave signals received by the user interface module 1310. The user intention interpretation module 1320 may utilize a machine-learning model to analyze the brainwave signals. Although this disclosure describes determining a user intention based on user signals in a particular manner, this disclosure contemplates determining a user intention based on user signals in any suitable manner.

In particular embodiments, the computing device 1201 may construct one or more first commands for a user device 1205 based on the determined user intention. The one or more first commands may be commands that are to be executed in order by the user device 1205 to fulfill the determined user intention. In order to construct the one or more first commands for the user device 1205, the computing device 1201 may select a user device 1205 that needs to perform one or more functions to fulfill the determined user intention among one or more available user devices 1205. The computing device 1201 may access current status information associated with the selected user device 1205. The computing device 1201 may communicate with the selected user device 1205 to access the current status information associated with the selected user device 1205. The current status information may comprise current environment information surrounding the selected user device 1205 or information associated with current state of the selected user device 1205. The computing device 1201 may construct the one or more commands that are to be executed by the selected user device 1205 from the current status associated with the selected user device 1205 to fulfill the determined user intention. As an example and not by way of limitation, continuing with a prior example illustrated in FIG. 4, the augmented-reality glasses 1410 may select a user device that needs to perform one or more functions to fulfill the determined user intention, which is “go to the convenience store across the street.” Since the user 1405 is riding the power wheelchair 1420, the augmented-reality glasses 1410 may select the power wheelchair 1420 among one or more available user devices for providing mobility to the user 1405. The communication module 1350 of the augmented-reality glasses 1410 may communicate with the power wheelchair 1410 to access up-to-date status information from the power wheelchair 1420. The status information may comprise environment information, such as one or more images surrounding the power wheelchair 1420. The status information may comprise device state information, such as a direction the power wheelchair 1420 is facing, a current position of the power wheelchair 1420, a current speed of the power wheelchair 1420, or a current battery level of the power wheelchair 1420. The command generation module 1340 of the augmented-reality glasses 1410 may compute a route from the current position of the power wheelchair 1420 to the destination, which is the convenience store across the street. The command generation module 1340 of the augmented-reality glasses may construct one or more commands the power wheelchair 1420 needs to execute to reach the destination from the current location. The command generation module 1340 may utilize a machine-learning model to construct the one or more commands. Although this disclosure describes construct one or more commands for a user device based on the determined user intention in a particular manner, this disclosure contemplates construct one or more commands for a user device based on the determined user intention in any suitable manner.

In particular embodiments, the computing device 1201 may send one of the one or more first commands to the user device 1205. The user device 1205 may comprise a communication module to communicate with the computing device 1201. The user device 1205 may be capable of executing each of the one or more commands upon receiving the command from the computing device 1201. In particular embodiments, the user device may comprise a power wheelchair, a refrigerator, a television, a heating, ventilation, and air conditioning (HVAC) device, or any Internet of Things (IoT) device. As an example and not by way of limitation, continuing with a prior example, the communication module 1350 of the augmented-reality glasses 1410 may send a first command of the one or more commands constructed by the command generation module 1340 to the power wheelchair 1420 through the established secure wireless communication link 1407. The wireless communication interface 1423 of the power wheelchair 1420 may receive the first command from the communication module 1350 of the augmented-reality glasses 1410. The wireless communication interface 1423 may forward the first command to an embedded processing unit. The embedded processing unit may be capable of executing each of the one or more commands generated by the command generation module 1340 of the augmented-reality glasses 1410. Although this disclosure describes sending a command to the user device in a particular manner, this disclosure contemplates sending a command to the user device in any suitable manner.

In particular embodiments, the computing device 1201 may receive status information associated with the user device 1205 from the user device 1205. The status information may be sent by the user device 1205 in response to the one of the one or more first commands. The status information may comprise current environment information surrounding the user device 1205 or information associated with current state of the user device 1205 upon executing the one of the one or more first commands. In particular embodiments, the computing device 1201 may determine that the one or the one or more first commands has been successfully executed by the user device 1205 based on the status information. The computing device 1201 may send one of the remaining of the one or more first commands to the user device 1205. As an example and not by way of limitation, continuing with a prior example illustrated in FIG. 4, the communication module 1350 of the augmented-reality glasses 1410 may receive a status information from the power wheelchair 1420 over the secure wireless communication link 1407. The status information may comprise new images corresponding to scenes surrounding the power wheelchair 1420. The status information may comprise an updated location of the power wheelchair 1420, an updated direction of the power wheelchair 1420, or an updated speed of the power wheelchair 1420 after executing the first command. The augmented-reality glasses 1410 may determine that the first command was successfully executed by the power wheelchair 1420 and send a second command to the power wheelchair 1420. In particular embodiments, the second command may be a command to change the speed. In particular embodiments, the second command may be a command to change the direction. In particular embodiments, the second command may be any suitable command that can be executed by the power wheelchair 1420. Although this disclosure describes sending a second command to the user device in a particular manner, this disclosure contemplates sending a second command to the user device in any suitable manner.

In particular embodiments, the computing device 1201 may, upon receiving status information from the user device 1205, determine that environment surrounding the user device has changed since the one or more first commands were constructed. The computing device 1201 may determine that state of the user device 1205 has changed since the one or more first commands were constructed. The computing device 1201 may determine that those changes require modifications to the one or more first commands. The computing device 1201 may construct one or more second commands for the user device 1205 based on the determination. The one or more second commands may be updated commands from the one or more first commands based on the received status information. The one or more second commands are to be executed by the user device 1205 to fulfill the determined user intention given the updated status associated with the user device 1205. The computing device 1201 may send one of the one or more second commands to the user device 1205. As an example and not by way of limitation, continuing with a prior example illustrated in FIG. 4, the augmented-reality glasses 1410 may determine that a traffic signal for a crosswalk has changed to red and the power wheelchair 1420 arrives to the crosswalk based on the status information received from the power wheelchair 1420. The command generation module 1340 of the augmented-reality glasses 1410 may construct a new command for the power wheelchair 1420 to stop. The communication module 1350 of the augmented-reality glasses 1410 may send the new command to the power wheelchair 1420. The augmented-reality glasses 1410 may construct a new one or more commands once the augmented-reality glasses 1410 receives a new status information indicating that the traffic signal for the crosswalk changes to green. Although this disclosure describes updating one or more commands based on status information received from a user device in a particular manner, this disclosure contemplates updating one or more commands based on status information received from a user device in any suitable manner.

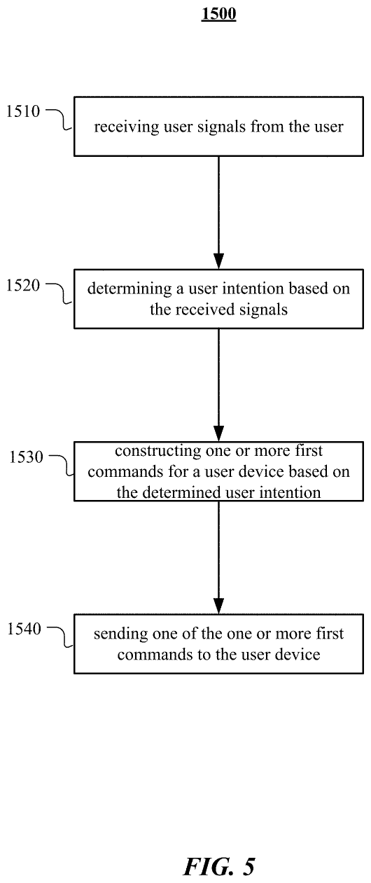

FIG. 5 illustrates an example method 1500 for controlling a user device based on an interpreted user intention. The method may begin at step 1510, where the computing device 1201 may receive user signals from the user. At step 1520, the computing device 1201 may determine a user intention based on the received signals. At step 1530, the computing device 1201 may construct one or more first commands for a user device based on the determined user intention. The one or more first commands are to be executed by the user device to fulfill the determined user intention. At step 1540, the computing device 1201 may send one of the one or more first commands to the user device. Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for controlling a user device based on an interpreted user intention including the particular steps of the method of FIG. 5, this disclosure contemplates any suitable method for controlling a user device based on an interpreted user intention including any suitable steps, which may include all, some, or none of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

### Generating High-Resolution Digital Maps Based on Low-Resolution Observations

In particular embodiments, a computing device may generate a three-dimensional first-resolution digital map of a geographic area in real world based on second-resolution observations on the geographic area using a machine-learning model, where the first resolution is higher than the second resolution. In particular embodiments, the second-resolution observations may be two-dimensional images. In particular embodiments, the second-resolution observations may be three-dimensional point cloud. In particular embodiments, the second-resolution observations may be captured by a camera associated with a user device including an augmented-reality glasses or a smartphone. A digital maps may comprise a three-dimensional feature layer comprising three-dimensional point clouds and a contextual layer comprising contextual information associated with points in the point cloud. With a digital map, a user device, such as an augmented-reality glasses, may be able to tap into the digital map rather than reconstructing the surroundings in real time, which allows significant reduction in compute power. Thus, a user device with a less powerful mobile chipset may be able to provide better artificial-reality services to the user. With the digital maps, the user device may provide teleportation experience to the user. Also, the user may be able to search and share real-time information about the physical world using the user device. The applications of the digital maps may include, but not limited to, digital assistant that brings user information associated with the location the user is in real time, an overlay that allows the user to anchor virtual content in the real world. For example, a user associated with an augmented-reality glasses may get showtimes just by looking at a movie theater's marquee. Previously, generating a high-resolution digital map for an area may require a plurality of high-resolution images capturing the geographic area. This approach requires high computing resources. Furthermore, the digital map generated by this approach may lack of contextual information. The systems and methods disclosed in this application allows generating the first-resolution digital map based on the second-resolution images. The generated digital map may comprise contextual information associated with points in the point cloud. Although this disclosure describes generating a three-dimensional high-resolution digital map of a geographic area in real world based on low-resolution observations on the geographic area using a machine-learning model in a particular manner, this disclosure contemplates generating a three-dimensional high-resolution digital map of a geographic area in real world based on low-resolution observations on the geographic area using a machine-learning model in any suitable manner.

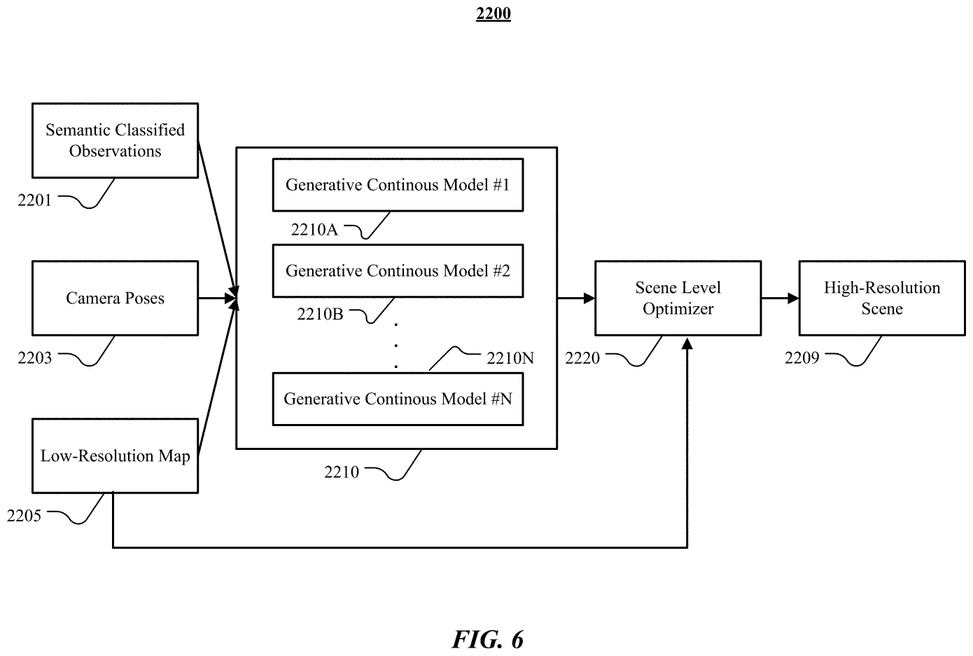

FIG. 6 illustrates an example system 2200 for generating high-resolution scenes based on low-resolution observations using a machine-learning model. In particular embodiments, a computing device may access a partial and/or sparse set of low-resolution observations for a geographic area and camera poses 2203 associate with the observations. In particular embodiments, a low-resolution observation may be a low-resolution two-dimensional image. In particular embodiments, the low-resolution observation may be a low-resolution three-dimensional point cloud. In particular embodiments, the low-resolution observations may be captured by a camera associated with a user mobile device, such as a smartphone or an augmented-reality glasses. In particular embodiments, the low-resolution observations may be semantically classified. Thus, the low-resolution observations may be semantic classified low-resolution observations 2201. In particular embodiments, the computing device may also access a low-resolution map 2205 for the geographic area. The low-resolution map 2205 may be an available aerial/satellite imagery or low-resolution point clouds such as local-government-provided dataset. Although this disclosure describes preparing data for generating high-resolution scenes in a particular manner, this disclosure contemplates preparing data for generating high-resolution scenes in any suitable manner.

In particular embodiments, the computing device may generate one or more high-resolution representations of one or more objects by processing the set of semantic classified low-resolution observations 2201 for the geographic area, camera poses 2203 associated with the low-resolution observations, and the low-resolution map 2205 for the geographic area using a machine-learning model 2210. The machine-learning model 2210 may be a collection of generative continuous models 2210A, 2210B, 2210N. Each generative continuous models 2210A, 2210B, 2210N corresponds to a semantic class of an object in the observations. In particular embodiments, objects detected within the low-resolution observation may be semantically classified. Thus, a semantic classified observations 2201 along with the corresponding camera poses 2203 and the low-resolution map 2205 may be processed through a corresponding generative continuous model within the machine-learning model 2210. The semantic class may include, but not limited to, humans, animals, natural landscape, structures, manufactured items, furniture. Each generative continuous models 2210A, 2210B and 2210N within the machine-learning model 2210 may be trained separately using respectively prepared training data. Technical details for the generative continuous models 2210A, 2210B, and 2210N can be found in arXiv:2003.10983 (2020), arXiv:1901.05103 (2019), arXiv:1809.05068 (2018), and arXiv:2005.05125 (2020). Although this disclosure describes generating one or more high-resolution representations of one or more objects by processing the set of semantic classified low-resolution observations, camera poses, and low-resolution map in a particular manner, this disclosure contemplates generating one or more high-resolution representations of one or more objects by processing the set of semantic classified low-resolution observations, camera poses, and low-resolution map in any suitable manner.

In particular embodiments, the computing device may combine the high-resolution digital representations of the one or more objects identified in the semantic classified low-resolution observations 2201. The computing device may perform a scene level optimization using a scene level optimizer 2220 to create a high-resolution three-dimensional scene 2209. For example, the computing device may optimize the combined representations to fit the low-resolution map 2205. Although this disclosure describes post-inference processes for generating a high-resolution scene in a particular manner, this disclosure contemplates post-inference processes for generating a high-resolution scene in any suitable manner.

In particular embodiments, training the machine-learning model 2210 may comprise training each of the generative continuous models 2210A, 2210B, and 2210N. The computing device may train a plurality of generative continuous models (e.g., using auto-decoder described in arXiv:1901.05103 (2019)) for different classes of objects (e.g., one model for furniture, another for trees, etc.) using prepared training data for each class. Each generative model may be conditioned on a latent code to represent the manifold of geometry and appearances. A generative model may be a combination of a decoder plus a latent code. Each generative continuous model may employ a different architecture and training scheme to exploit similarities in those classes and reduce the capacity needed for the model to generalize to everything. For example, a generative continuous model for human/animals may be a codec-avatar-like scheme, while a generative continuous model for a furniture may be a model in arXiv:2005.05125 (2020). A generative continuous model for landscapes may utilize procedural synthesis techniques. Although this disclosure describes training a generative continuous model for a semantic class in a particular manner, this disclosure contemplates a generative continuous model for a semantic class in any suitable manner.

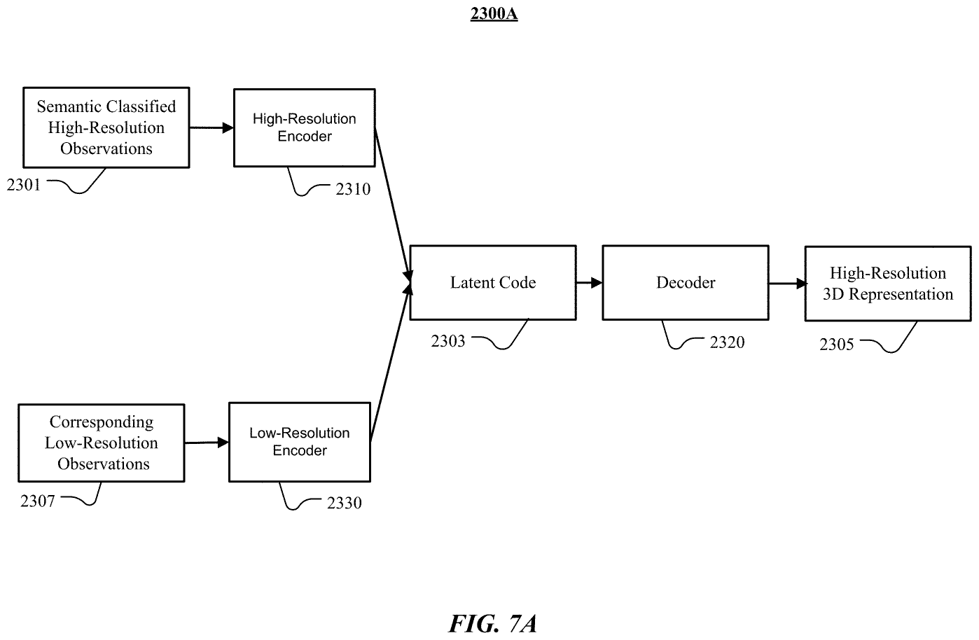

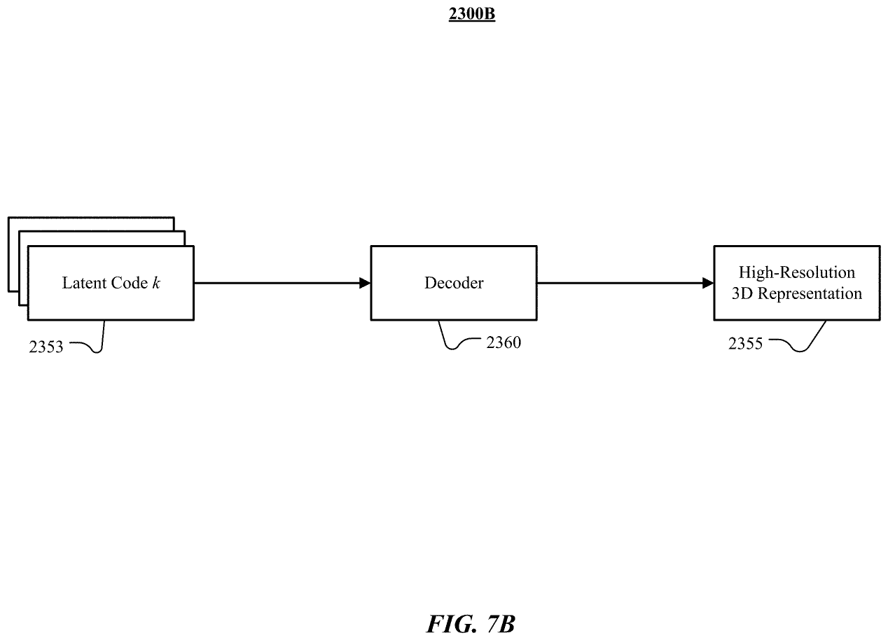

In particular embodiments, a computing device may train a machine-learning model 2210 that comprises a plurality of generative continuous models 2210A, 2210B, and 2210N. The computing device may train each generative continuous model one by one. FIG. 7A illustrates an example system 2300A for training an auto-encoder generative continuous model. The computing device may access training data for the auto-encoder generative continuous model. The auto-encoder generative continuous model may comprise a high-resolution encoder 2310, decoder 2320, and a low-resolution encoder 2330. To prepare the training data for an auto-encoder generative continuous model, the computing device may construct a set of training samples by selecting semantic classified high-resolution observations 2301 corresponding to the auto-encoder generative continuous model among the available semantic classified high-resolution observations. For example, the computing device may select semantic classified high-resolution observations 2301 comprising human beings for training an auto-encoder generative continuous model for human. The computing device may select semantic classified high-resolution observations 2301 comprising building structures for training a generative continuous model for building structures. The classes may include, but not limited to, humans, animals, natural landscape, structures, manufactured items, furniture, and any suitable object classes found in real world. In particular embodiments, the high-resolution observations may be two-dimensional high-resolution images. In particular embodiments, the high-resolution observations may be three-dimensional high-resolution point cloud. To capture the high-resolution observations, ultra-high-resolution laser, camera and high-grade Global Positioning System (GPS)/Inertial Measurement Unit (IMU) may be used. The high-resolution observations may be classified into classes of corresponding objects. Although this disclosure describes preparing training data to train an auto-encoder generative continuous model in a particular manner, this disclosure contemplates preparing training data to train an auto-encoder generative continuous model in any suitable manner.

In particular embodiments, the computing device may train the high-resolution encoder 2310 and the decoder 2320 using the set of semantic classified high-resolution observations 2301 as training data. The high-resolution encoder 2310 may generate a latent code 2303 for a given semantic classified high-resolution observation 2301. The decoder 2320 may generate a high-resolution three-dimensional representation 2305 for a given latent code 2303. The gradients may be computed using a loss function based on difference between a ground truth high-resolution three-dimensional representation and the generated high-resolution three-dimensional representation 2305 for each semantic classified high-resolution observation 2301 in the set of training samples. A backpropagation procedure with the computed gradients may be used for training the high-resolution encoder 2310 and the decoder 2320 until a training goal is reached. Although this disclosure describes training the high-resolution encoder and the decoder of an auto-encoder generative continuous model in a particular manner, this disclosure contemplates training the high-resolution encoder and the decoder of an auto-encoder generative continuous model in any suitable manner.

In particular embodiments, once the training of the high-resolution encoder 2310 and the decoder 2310 of an auto-encoder generative continuous model finishes, the computing device may train the low-resolution encoder 2330. The computing device may prepare a set of low-resolution observations 2307 respectively corresponding to the set of semantic classified high-resolution observations 2301. The computing device may train the low-resolution encoder 2330 using the prepared set of low-resolution observations 2307. The low-resolution encoder 2330 may generate a latent code 2303 for a given low-resolution observation 2307. The computing device may compute gradients using a loss function based on difference between the generated latent code 2303 and a latent code 2303 the high-resolution encoder 2310 generates for a corresponding high-resolution observation 2301. A backpropagation procedure with the computed gradients may be used for training the low-resolution encoder 2330. The details of training an auto-encoder generative continuous model may be found in arXiv:2003.10983 (2020), arXiv:1901.05103 (2019), arXiv:1809.05068 (2018), and arXiv:2005.05125 (2020). Although this disclosure describes training the low-resolution encoder of an auto-encoder generative continuous model in a particular manner, this disclosure contemplates training the low-resolution encoder of an auto-encoder generative continuous model in any suitable manner.

In particular embodiments, the generative continuous model may be an auto-decoder generative continuous model. FIG. 7B illustrates an example system 2300B for training an auto-decoder generative continuous model. The computing device may access training data for the auto-decoder generative continuous model. The auto-decoder generative continuous model may comprise a plurality of latent codes 2353 and a decoder 2360. To prepare the training data for an auto-decoder generative continuous model, the computing device may construct a set of training samples by selecting high-resolution three-dimensional representations corresponding to the auto-decoder generative continuous model among the available high-resolution three-dimensional representations. For example, the computing device may select high-resolution three-dimensional representations for animals for training an auto-decoder generative continuous model for animals. The high-resolution three-dimensional representations may be created based on semantic classified high-resolution observations. Before training the auto-decoder generative continuous model, the computing device may initialize the plurality of latent codes 2353 with random values. Each of the plurality of latent codes 2353 may correspond to a shape. Although this disclosure describes preparing training data to train an auto-decoder generative continuous model in a particular manner, this disclosure contemplates preparing training data to train an auto-decoder generative continuous model in any suitable manner.

In particular embodiments, the computing device may train the auto-decoder generative continuous model. During the training procedure, the plurality of latent codes 2353 and the decoder 2360 may be optimized to generate a high-resolution three-dimensional representation 2355 for a given latent code 2353 representing a shape. The gradients may be computed using a loss function based on difference between a ground truth high-resolution three-dimensional representation corresponding to a shape in the prepared set of training samples and the generated high-resolution three-dimensional representation 2355 for a given latent code corresponding to the shape. A backpropagation procedure with the computed gradients may be used for training the decoder 2360 and for optimizing the plurality of latent codes 2353. Although this disclosure describes training an auto-decoder generative continuous model in a particular manner, this disclosure contemplates training an auto-decoder generative continuous model in any suitable manner.

In particular embodiments, the computing device may estimate an optimal latent code 2353 for a given semantic classified low-resolution observation when generating high-resolution scenes based on low-resolution observations using the auto-decoder generative continuous model. The estimated optimal latent code 2353 may be provided to the auto-decoder generative continuous model to generate a high-resolution three-dimensional representation. An auto-decode generative continuous model can be trained with high-resolution training data only without requiring low-resolution training data. However, the low-resolution data can be used for inferring high-resolution three-dimensional representations. The details of training an auto-decoder generative continuous model and inferring high-resolution three-dimensional representations may be found in arXiv:1901.05103 (2019). Although this disclosure describes generating high-resolution three-dimensional representations using an auto-decoder generative continuous model in a particular manner, this disclosure contemplates generating high-resolution three-dimensional representations using an auto-decoder generative continuous model in any suitable manner.

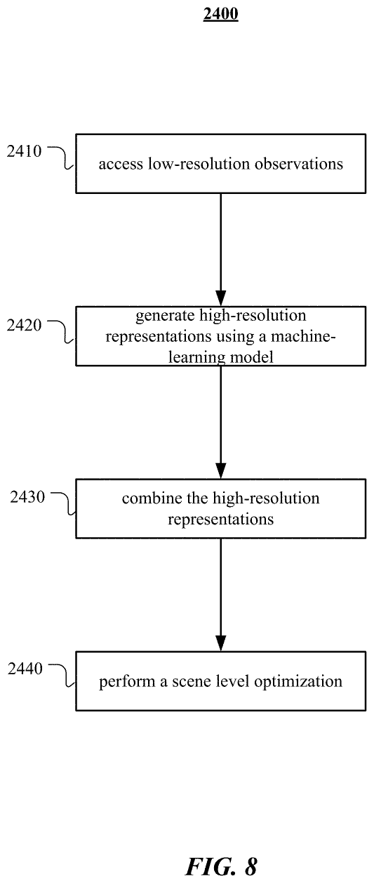

FIG. 8 illustrates an example method 2400 for generating high-resolution scenes based on low-resolution observations using a machine-learning model. The method may begin at step 2410, where a computing device access low-resolution observations. The computing device may access a partial and/or sparse set of low-resolution observations for a geographic area and camera poses associate with the observations. The computing device may also access a low-resolution map for the geographic area. At step 2420, the computing device may generate one or more high-resolution representations of one or more objects by processing the set of semantic classified low-resolution observations for the geographic area, camera poses associated with the low-resolution observations, and the low-resolution map for the geographic area using a machine-learning model. At step 2430, the computing device may combine the high-resolution digital representations of the one or more objects identified in the semantic classified low-resolution observations. At step 2440, the computing device may perform a scene level optimization using a scene level optimizer to create a high-resolution three-dimensional scene. Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method for generating high-resolution scenes based on low-resolution observations using a machine-learning model including the particular steps of the method of FIG. 8, this disclosure contemplates any suitable method for generating high-resolution scenes based on low-resolution observations using a machine-learning model including any suitable steps, which may include all, some, or none of the steps of the method of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of the method of FIG. 8.

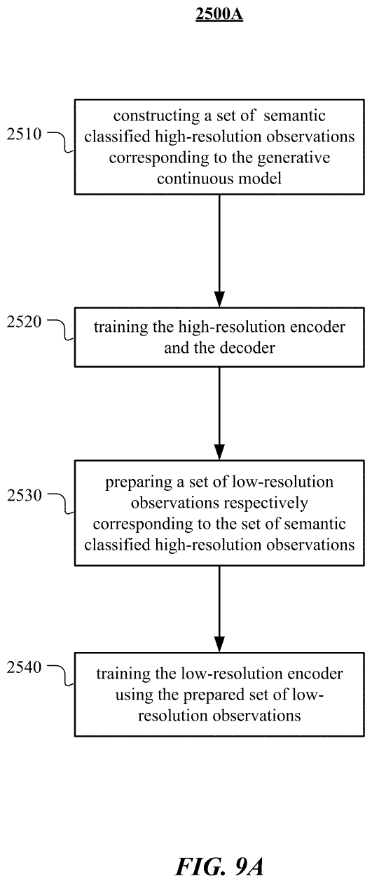

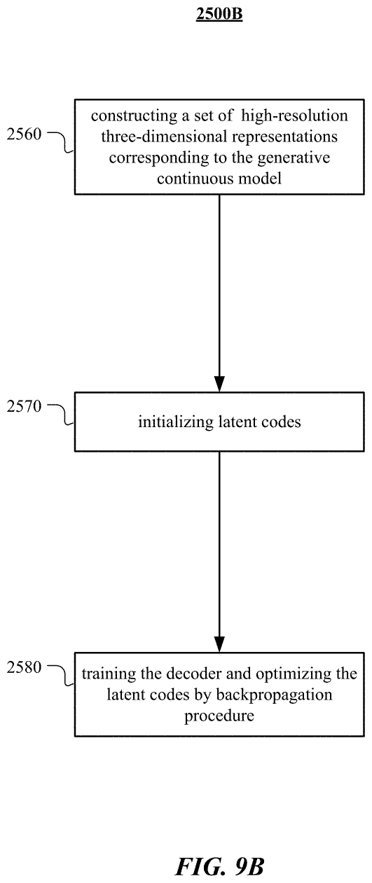

FIG. 9A illustrates an example method 2500A for training an auto-encoder generative continuous model. The method may begin at step 2510, where the computing device may construct a set of training samples by selecting semantic classified high-resolution observations corresponding to the generative continuous model among the available semantic classified high-resolution observations. At step 2520, the computing device may train the high-resolution encoder and the decoder using the set of semantic classified high-resolution observations as training data. The high-resolution encoder may generate a latent code for a given semantic classified high-resolution observation. The decoder may generate a high-resolution three-dimensional representation for a given latent code. At step 2530, the computing device may prepare a set of low-resolution observations respectively corresponding to the set of semantic classified high-resolution observations. At step 2540, the computing device may train the low-resolution encoder using the prepared set of low-resolution observations. Particular embodiments may repeat one or more steps of the method of FIG. 9A, where appropriate. Although this disclosure describes and illustrates particular steps of the method of FIG. 9A as occurring in a particular order, this disclosure contemplates any suitable steps of the method of FIG. 9A occurring in any suitable order. Moreover, although this disclosure describes and illustrates an example method for training an auto-encoder generative continuous model including the particular steps of the method of FIG. 9A, this disclosure contemplates any suitable method for training an auto-encoder generative continuous model including any suitable steps, which may include all, some, or none of the steps of the method of FIG. 9A, where appropriate. Furthermore, although this disclosure describes and illustrates particular components, devices, or systems carrying out particular steps of the method of FIG. 9A, this disclosure contemplates any suitable combination of any suitable components, devices, or systems carrying out any suitable steps of the method of FIG. 9A.

FIG. 9B illustrates an example method 2500B for training an auto-decoder generative continuous model. The method may begin at step 2560, where the computing device may construct a set of training samples by selecting high-resolution three-dimensional representations corresponding to the auto-decoder generative continuous model among the available high-resolution three-dimensional representations. At step 2570, the computing device may initialize the plurality of latent codes with random values. At step 2580, the computing device may train the decoder and optimize the plurality of latent codes by performing a backpropagation procedure with the constructed set of high-resolution three-dimensional representations. Particular embodiments may repeat one or more steps of the method of FIG. 9B, where appropriate. Although this disclosure describes and illustrates particular steps of the method of FIG. 9B as occurring in a particular order, this disclosure contemplates any suitable steps of the method of FIG. 9B occurring in any suitable order. Moreover, although this disclosure describes and illustrates an example method for training an auto-decoder generative continuous model including the particular steps of the method of FIG. 9B, this disclosure contemplates any suitable method for training an auto-decoder generative continuous model including any suitable steps, which may include all, some, or none of the steps of the method of FIG. 9B, where appropriate. Furthermore, although this disclosure describes and illustrates particular components, devices, or systems carrying out particular steps of the method of FIG. 9B, this disclosure contemplates any suitable combination of any suitable components, devices, or systems carrying out any suitable steps of the method of FIG. 9B.

Visual Odometry without Initialization

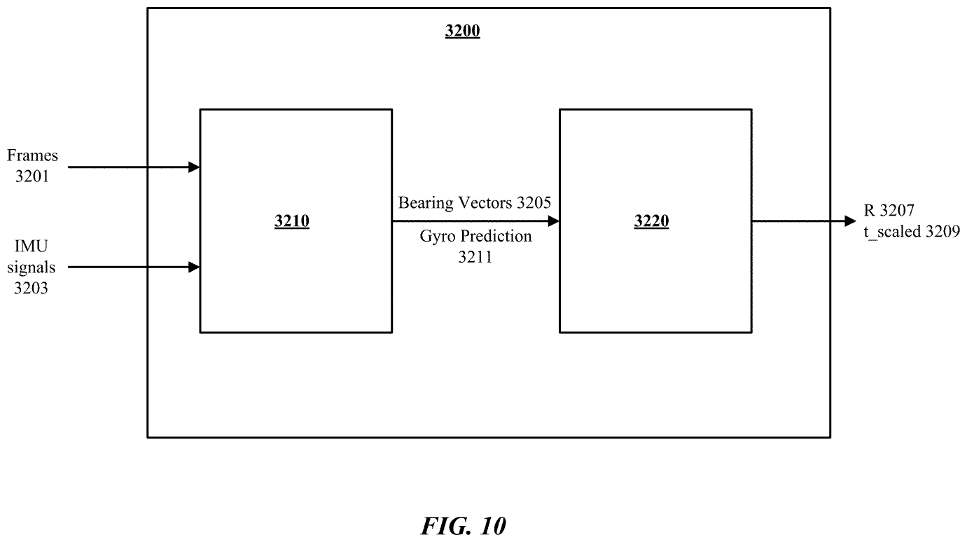

FIG. 10 illustrates an example logical architecture of First Frame Tracker (FFT) 3200. FFT 3200 comprises Frame-to-Frame Tracker 3210 and First Frame Pose Estimator 3220. Frame-to-Frame Tracker 3210 may access frames 3201 of a video stream captured by a camera. Frame-to-Frame Tracker 3210 may also access signals 3203 from IMU sensors associated with the camera. Frame-to-Frame Tracker 3210 may forward bearing vectors 3205 corresponding to tracked features in the frames 3201 to First Frame Pose Estimator 3220. Frame-to-Frame Tracker 3210 may also forward gyro prediction 3211 to First Frame Pose Estimator 3220. First Frame Pose Estimator 3220 may compute rotation 3207 and scaled translation 3209 of the camera with respect to a previous keyframe based on the input bearing vectors 3205 and the gyro prediction 3211. First Frame Pose Estimator 3220 may send the computed rotation 3207 and scaled translation 3209 to an artificial-reality application. Although this disclosure describes a particular architecture of FFT, this disclosure contemplates any suitable architecture of FFT.

In particular embodiments, a computing device 3108 may access a first frame 3201 of a video stream captured by a camera associated with the computing device 3108. The computing device 3108 may also access signals 3203 from IMU sensors associated with the camera. As an example and not by way of limitation, an artificial-reality application may run on the computing device 3108. The artificial-reality application may need to construct a map associated with the environment that is being captured by the camera associated with the computing device 3108. A position and/or a pose of the camera may be required to construct the map. Thus, the computing device 3108 may activate the camera associated with the computing device 3108. Frame-to-Frame Tracker 3210 may access a series of image frames 3201 captured by the camera associated with the computing device 3108. The computing device 3108 may also activate IMU sensors associated with the camera. Frame-to-Frame Tracker 3210 may also access real-time signals 3203 from IMU sensors associated with the camera. Although this disclosure describes accessing an image frame and IMU signals in a particular manner, this disclosure contemplates accessing an image frame and IMU signals in any suitable manner.

In particular embodiments, the computing device 3108 may compute bearing vectors 3205 corresponding to tracked features in the first frame. To compute the bearing vectors 3205 corresponding to the tracked features in the first frame, the computing device 3108 may access bearing vectors 3205 corresponding to the tracked features in a previous frame of the first frame. The computing device 3108 may compute bearing vectors 3205 corresponding to the tracked features in the first frame based on the computed bearing vectors 3205 corresponding to the tracked features in the previous frame and an estimated relative pose of the camera corresponding to the first frame with respect to the previous frame. In particular embodiments, epipolar constraints may be used to reduce a search radius for computing the bearing vectors 3201 corresponding to the tracked features in the first frame. As an example and not by way of limitation, continuing with a prior example, Frame-to-Frame Tracker 3210 may compute bearing vectors 3205 corresponding to tracked features in frame t. Frame-to-Frame Tracker 3210 may access computed bearing vectors 3205 corresponding to the tracked features in frame t-1. Frame-to-Frame Tracker 3210 may estimate relative pose of the camera corresponding to frame t with respect to frame t-1. Frame-to-Frame Tracker 3210 may compute bearing vectors 3205 corresponding to the tracked features in frame t based on the computed bearing vectors 3205 corresponding to the tracked features in frame t-1 and the estimated relative pose of the camera corresponding to frame t with respect to frame t-1. Frame-to-Frame Tracker 3210 may use epipolar constraints to reduce a search radius for computing the bearing vectors 3201 corresponding to the tracked features in frame t. Frame-to-Frame Tracker 3210 may forward the computed bearing vectors 3205 corresponding to the tracked features in frame t to First Frame Pose Estimator 3220. Although this disclosure describes computing bearing vectors corresponding to tracked features in a frame in a particular manner, this disclosure contemplates computing bearing vectors corresponding to tracked features in a frame in any suitable manner.

In particular embodiments, the relative pose of the camera corresponding to the first frame with respect to the previous frame may be estimated based on signals 3203 from the IMU sensors. As an example and not by way of limitation, continuing with a prior example, Frame-to-Frame Tracker 3210 may estimate the relative pose of the camera corresponding to frame t with respect to frame t-1 based on signals 3203 from the IMU sensors. Although this disclosure describes estimating a relative pose of a camera corresponding to a frame with respect to a previous frame in a particular manner, this disclosure contemplates estimating a relative pose of a camera corresponding to a frame with respect to a previous frame in any suitable manner.

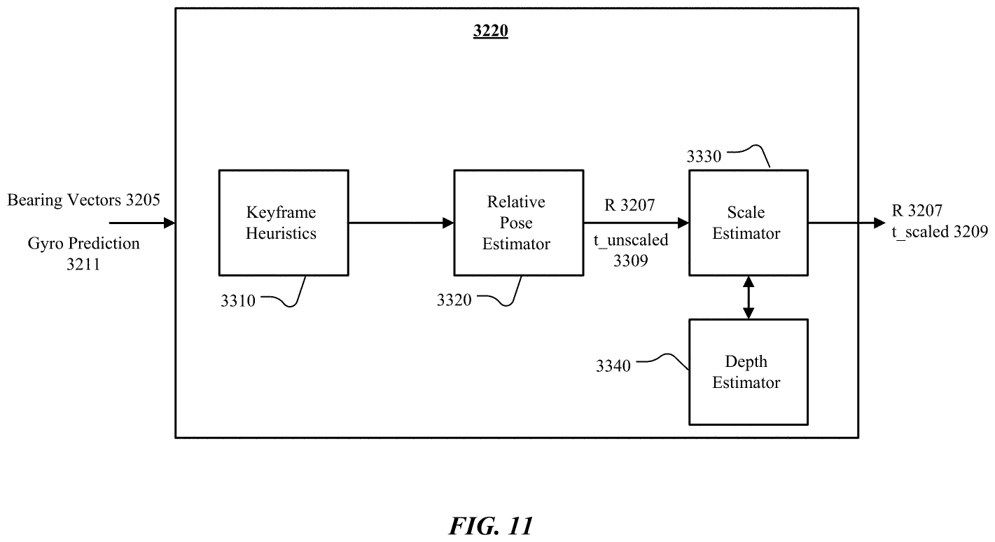

FIG. 11 illustrates an example logical architecture of First Frame Pose Estimator 3220. First Frame Pose Estimator 3220 may receive bearing vectors 3205 corresponding to tracked features in frames. First Frame Pose Estimator 3220 may also receive gyro prediction 3211 determined based on real-time signals from a gyroscope associated with the camera. A keyframe heuristics module 3310 of First Frame Pose Estimator 3220 may choose a keyframe among the frames once in a while. A relative pose estimator module 3320 may compute a rotation 3207 and an unscaled translation 3309 of the camera corresponding to a frame with respect to a previous keyframe. A scale estimator 3330 may determine a scaled translation 3209 of the camera corresponding to a frame with respect to the previous keyframe. The scale estimator 3330 may communicate with a depth estimator 3340. Although this disclosure describes a particular architecture of First Frame Pose Estimator, this disclosure contemplates any suitable architecture of First Frame Pose Estimator.

In particular embodiments, the computing device 3108 may compute a rotation 3207 and an unscaled translation 3309 of the camera corresponding to the first frame with respect to a previous keyframe. Computing the rotation 3207 and the unscaled translation 3309 of the camera corresponding to the first frame with respect to the previous keyframe may comprise optimizing an objective function of 3 Degree of Freedom (DoF) rotation and 2 DoF unit norm translation. In particular embodiments, the computing device 3108 may minimize the Jacobians of the objective function instead of minimizing the objective function. This approach may make the dimension of the residual equal to the number of unknowns. The computing device 3108 may also improve the results by including the objective function itself in the cost function. The properties of the estimation can be tuned by differently weighting the Jacobians and 1-d residual. As an example and not by way of limitation, the relative pose estimator module 3320 may compute a rotation 3207 and an unscaled translation 3309 of the camera corresponding to frame t with respect to a previous keyframe k, where k<t. The relative pose estimator module 3320 may utilize bearing vectors 3205 corresponding to the tracked features in frame t and bearing vectors 3205 corresponding to the tracked features in frame k for optimizing the objective function. In particular embodiments, Although this disclosure describes computing a rotation and an unscaled translation of the camera corresponding to the first frame with respect to a previous keyframe in a particular manner, this disclosure contemplates computing a rotation and an unscaled translation of the camera corresponding to the first frame with respect to a previous keyframe in any suitable manner.

In particular embodiments, the computing device 3108 may remove outliers by only estimating the direction of the translation vector using a closed form solution. The inputs to the closed form solution may be the relative rotation (gyro prediction 3211) and the bearing vectors 3205. Once the outliers are removed, the computing device 3108 may re-estimate the relative transformation using the relative pose estimator module 3320. If a good gyro prediction 3211 is not available, the computing device 3108 may randomly generate a gyro prediction 3211 within a Random sample consensus (RANSAC) framework. Although this disclosure describes removing outlier features in a particular manner, this disclosure contemplates removing outlier features in any suitable manner.

In particular embodiments, the previous keyframe may be determined based on heuristics by the keyframe heuristics module 3310. In particular embodiments, the keyframe heuristics module 3310 may determine a new keyframe when computing a rotation 3207 and an unscaled translation 3309 of the camera corresponding to a frame with respect to the previous keyframe fails. As an example and not by way of limitation, the relative pose estimator module 3320 may fail to compute a rotation 3207 and an unscaled translation 3309 of the camera corresponding to frame t with respect to the previous keyframe k because the tracked features in the previous keyframe k may not match well to the tracked features in frame t. In such a case, the keyframe heuristics module 3310 may determine a new keyframe k′. In particular embodiments, frame k′ may be a later frame than frame k. In particular embodiments, the keyframe heuristics module 3310 may determine a new keyframe in a regular interval. The regular interval may become short when the camera moves fast while the regular interval may become long when the camera moves slow. As an example and not by way of limitation, the camera moves fast. Then, a probability that a feature in a frame may not exist in from another frame becomes higher. Thus, the keyframe heuristics module 3310 may configure the regular interval short, such that a new keyframe is determined more often. When the camera moves slow, the keyframe heuristics module 3310 may configure the regular interval long, such that a new keyframe is determined less often. Although this disclosure describes determining a new keyframe in a particular manner, this disclosure contemplates determining a new keyframe in any suitable manner.

In particular embodiments, the computing device 3108 may determine a scaled translation 3209 of the camera corresponding to the first frame with respect to the previous keyframe by computing a scale of the translation. Determining the scale of the translation may comprise minimizing the squared re-projection errors of the features with estimated depth based on features of the current frame and re-projected features of the previous keyframe to the first frame. A Gauss-Newton algorithm is used for the minimization. As the depth of the features is not known for the first frame, a constant depth may be assumed. As an example and not by way of limitation, the scale estimator module 3330 may determine a scaled translation of the camera corresponding to frame t with respect to the previous keyframe k. The scale estimator module 3330 may re-project the tracked features in the previous keyframe k into frame t. The scale estimator module 3330 may minimize the squared re-projection errors of the features with estimated depth acquired from a depth estimator module 3340. The depth estimator module 3340 may estimate the depth of features by points filters of a 3d-2d tracker. Although this disclosure describes determining a scaled translation of the camera in a particular manner, this disclosure contemplates determining a scaled translation of the camera in any suitable manner.

In particular embodiments, the computing device 3108 may send the rotation 3207 and the scaled translation 3209 of the camera corresponding to the first frame with respect to the previous keyframe to an application utilizing a pose information. As an example and not by way of limitation, an artificial-reality application may utilize the pose information. The FFT 3200 may send the rotation 3207 and the scaled translation 3209 of the camera to the artificial-reality application. Although this disclosure describes sending the rotation and the scaled translation of the camera to an application in a particular manner, this disclosure contemplates sending the rotation and the scaled translation of the camera to an application in any suitable manner.

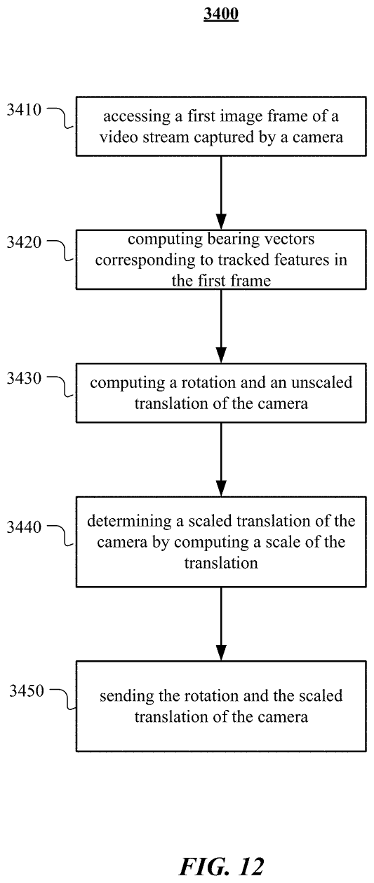

FIG. 12 illustrates an example method 3400 for estimating a pose of a camera without initializing SLAM. The method may begin at step 3410, where the computing device 3108 may access a first frame of a video stream captured by a camera. At step 3420, the computing device 3108 may compute bearing vectors corresponding to tracked features in the first frame. At step 3430, the computing device 3108 may compute a rotation and an unscaled translation of the camera corresponding to the first frame with respect to a second frame. The second frame may be a previous keyframe. The previous keyframe may be determined based on heuristics. At step 3440, the computing device 3108 may determine a scaled translation of the camera corresponding to the first frame with respect to the second frame by computing a scale of the translation. At step 3450, the computing device 3108 may sending the rotation and the scaled translation of the camera corresponding to the first frame with respect to the second frame to a module utilizing a pose information. Particular embodiments may repeat one or more steps of the method of FIG. 12, where appropriate. Although this disclosure describes and illustrates particular steps of the method of FIG. 12 as occurring in a particular order, this disclosure contemplates any suitable steps of the method of FIG. 12 occurring in any suitable order. Moreover, although this disclosure describes and illustrates an example method for estimating a pose of a camera without initializing SLAM including the particular steps of the method of FIG. 12, this disclosure contemplates any suitable method for estimating a pose of a camera without initializing SLAM including any suitable steps, which may include all, some, or none of the steps of the method of FIG. 12, where appropriate. Furthermore, although this disclosure describes and illustrates particular components, devices, or systems carrying out particular steps of the method of FIG. 12, this disclosure contemplates any suitable combination of any suitable components, devices, or systems carrying out any suitable steps of the method of FIG. 12.

### Distributed Image Rendering Between Multiple Personal Devices

Different computing devices have different advantages. Tradeoffs are made between computing power, battery life, accessibility, and visual range. For example, glasses rank highly in visual range but have lower computing power and battery life than a laptop. The ability to connect multiple devices through a network opens the door to mixing and matching some of these advantages. Running applications (apps) can take up a large amount of computing power and battery life. For this reason, it is desirable to have the ability to run the apps on a computing device with more system resources, such as a watch, and project the images onto a device that, though has more limited system resources, is in a better visual range for a user, such as smart glasses. However, the amount of data transfer required to move an image from a watch to glasses over a network is immense, causing delays and excessive power loss. Thus, it would be beneficial to have a method of reducing the amount of data transfer required between these two devices. It also may be desirable to be able to run multiple apps at once in different lines of sight, much like using multiple monitors at a workstation but for use when a person is on the go.

This invention describes systems and processes that enable one mobile device to use the display of another mobile device to display content. For ease of reference and clarity, this disclosure would use the collaboration between a smart watch and a pair of smart glasses as an example to explain the techniques described herein. However, the computing device where the app resides (transferor device) or where the content is displayed (transferee device) may be, for example, a smart watch, smart glasses, a cell phone, a tablet, or a laptop. This invention solves the previously described problem of massive amounts of data transfer by sending instructions to the glasses for forming an image rather than sending the image itself.

In one embodiment, the outputting computing device, such as a smart watch, does the bulk of the computing. An app, such as a fitness app, is run on this device. The user may be wearing a smart watch on her wrist and a pair of smart glasses on her face. While the smart watch has the power to run her apps, in many instances, such as during exercise, it may be inconvenient to have to look down at her watch.

An embodiment of the invention is directed to a method that solves problems associate with large amounts of data transfer and differences in display size between two connected devices. This connection can be through wires or through a variety of wireless means such as through a local area network (LAN) such as Wi-Fi or a personal area network (PAN) such as Bluetooth, infrared, Zigbee, and ultrawideband (UWB) technology. Many methods allow for a short-range connection between two or more devices. For example, an individual may own a watch and glasses and wish to use them at the same time in a way that data can be exchanged between them in real-time. The devices, such as with a watch and glasses, may be different in terms of size, computational power, and display.

For example, a person may be running while wearing a watch and glasses, each being equipped with a computational device that is capable of running and displaying content generated by apps. This individual may run apps primarily on the watch, which has a higher computational capability, storage, or power or thermal capacity. The individual may wish to be able to view one app on the watch while viewing another on the display of the glasses. The user may instruct the watch to send content generated by the second app to the glasses for display. In one embodiment, the user's instruction may cause the CPU of the watch to generate rendering commands for the GPU to render the visual aspects associated with the app. If the app is to be run on the watch display, the rendering command is sent directly to the GPU of the watch. If, however, the user wishes the visual aspects associated with the app to be displayed on the glasses display, the rendering command is sent over the connection to the GPU of the glasses. It is the GPU of the glasses that renders the visual aspects associated with the app. This is different from the naïve method of sending the completed image over the connection to the glasses display. It saves cost associated with data transfer since the commands (generated instructions) require less data than the rendered image.

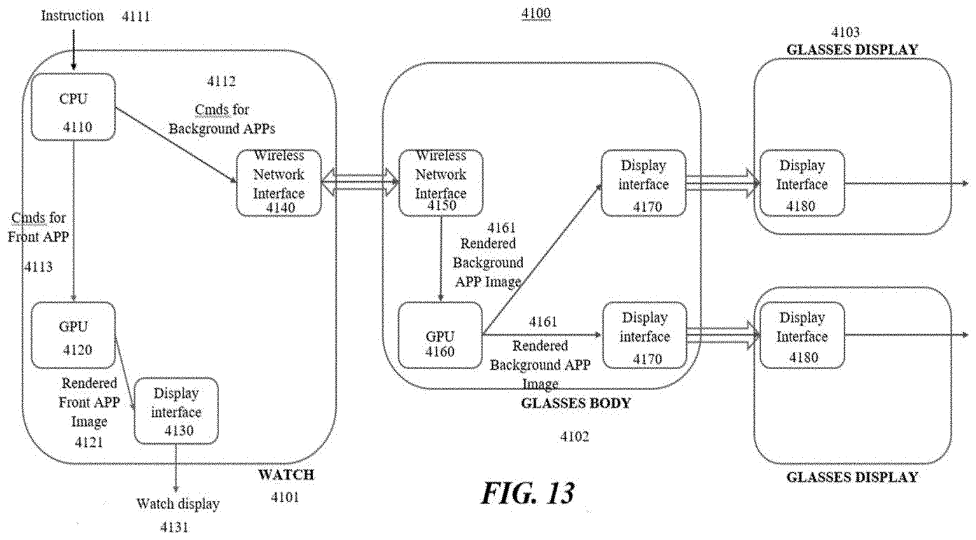

FIG. 13 illustrates an example system block diagram for generating and distributing rendering instructions between two connected devices. This system 4100 specifically runs an application on one device and generates the image of that app on another device. FIG. 13 shows, as an example, the first device being a watch 4101 and the second being glasses (represented by the body of the glasses 4102 and two lens displays 4103). However, the two or more devices can be any combination of devices capable of being connected. For example, instead of a watch, the first computing device may be a mobile device such as a cellphone, laptop, or tablet, and the second computing device may be glasses, a watch, or a cellphone The method may begin with instructions 4111 input into the watch 4101 and its computing system. In other embodiments, the watch instructions may instead be given as input to the other computing device and relayed back to the first one. Either way, the input instructions may come in a variety of forms, such as, for example, voice command, typing, tapping, or swiping controls. An app executed by the CPU of the watch 4110 may receive these instructions 4111 related to use of the app. The CPU 4110 then generates and sends rendering commands 4113 to the GPU of the watch 4120. The apps that are to be run in the foreground on the watch may be called the front app. For example, the front app may be a fitness tracker used by a device user on a run, and the status of the fitness tracker is to be displayed by the watch. Next, the GPU renders the display for front app 4121 and sends the rendered image to the watch display interface 4130, which in turn sends the image to the watch's display 4131.

Simultaneously or separately, the CPU 4110 on the watch 4101 may generate rendering commands 4112 for the same app that generated command 4113 or for a different app. The app that caused the CPU 4110 to generate command 4112 may be called a background app since it is running in the background and its content will not be shown on the watch 4101. For example, the background app may be one for playing music while the same user is on their run. Moving the content generated by the background app from the watch 4101 to the glasses is done by first sending the rendering commands 4112 for rendering the background app's content to the communication connection on the watch side 4140, which may be a wired or a wireless interface. FIG. 13 shows an example where a wireless interface is used. The connection can be through Bluetooth or Wi-Fi, for example. The wireless network interface on the watch side 4140 sends the rendering command 4112 to the wireless network interface 4150 on the body of the glasses 4102. The commands 4112 are sent from the wireless network interface 4150 to the GPU 4160 of the glasses. The GPU renders the image 4161 for the background app according to the rendering command 4112 and sends the rendered image 4161 to the display interface 4170 on the glasses body 4102. In one embodiment, the display interface 4170 on the glasses body 4102 and the display interfaces 4180 on the glasses lens displays 4103 are connected by wires or circuits. Once the image of the app has reached the glasses lens display 4103, the image is presented to the user. The foreground app and the background app could switch roles. For example, the fitness activity app may be displayed on the glasses (the fitness activity app is running as the background app) to allow the user to make a music selection on the watch (the music app is running as the foreground app on the watch). Later, the music app may be moved back to being the background app and displayed on the glasses so that the user could make a selection on the fitness activity app on the watch (the fitness activity app is now running as the foreground app on the watch). In other embodiments, the same app could cause multiple rendering commands to be generated and executed on different devices. For example, the same music app running on the watch could generate rendering commands for a playlist and instruct the glasses to render and display it. At the same time, the music app could generate another set of rendering commands for the current song being played and instruct the watch to render and display it.

The Particular embodiments may repeat one or more steps of the method of FIG. 13, where appropriate. Although this disclosure describes and illustrates particular steps of the method of FIG. 13 as occurring in a particular order, this disclosure contemplates any suitable steps of the method of FIG. 13 occurring in any suitable order. Moreover, although this disclosure describes and illustrates an example method for running an application on one device and generating the image of that app on another device including the particular steps of the method of FIG. 13, this disclosure contemplates any suitable method for running an application on one device and generating the image of that app on another device including any suitable steps, which may include all, some, or none of the steps of the method of FIG. 13, where appropriate. Furthermore, although this disclosure describes and illustrates particular components, devices, or systems carrying out particular steps of the method of FIG. 13, this disclosure contemplates any suitable combination of any suitable components, devices, or systems carrying out any suitable steps of the method of FIG. 13.

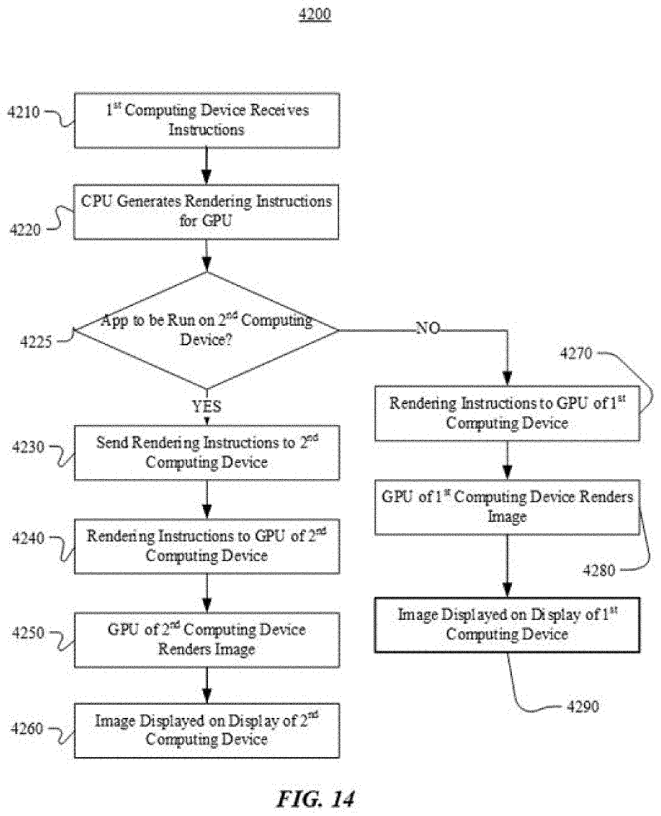

FIG. 14 illustrates example process 4200 for generating and distributing rendering instructions from one device to another. In particular embodiments, a first computing device receives instructions regarding an app at Step 4210. In Step 4220, the CPU of the first computing device generates rendering instructions for a GPU to render the image associated with the app. Step 4225 asks whether the app is to be displayed on the first computing device or a second computing device. If the answer to the question is yes, the system sends, at Step 4230, the rendering instructions to the second computing device. At Step 4240, the rendering instructions are then sent to the GPU of the second computing device, which then renders the image at Step 4250. At Step 4260, the rendered image is then displayed on the display of the second computing device. Returning to Step 4225, if the answer is no, the rendering instructions are sent to the GPU of the first computing device at Step 4270. At Step 4280, the GPU of the first computing device then renders the image of the app. At Step 4290, image is displayed on the display of the first computing device.

### Wearable Ubiquitous Mobile Communication Device

Even as AR devices such as smart glasses become more popular, several factors hinder their broader adoption for everyday use. As an example, the amount and size of the electronics, batteries, sensors, and antennas required to implement AR functionalities are often too large to fit within the glasses themselves. But even when some of these electronics are offloaded from the smart glasses to a separate handheld device that communicates wirelessly with the smart glasses, the smart glasses often remain unacceptably bulky and too heavy, hot, or awkward-looking for everyday wear.

Further challenges of smart glasses and accompanying handheld devices include the short battery life and high power consumption of both devices, which may even cause thermal shutdowns of the device(s) during heavy use cases like augmented calling. Battery life may further force a user to carry both the accompanying handheld device as well as their regular cell phone, rather than allowing the cell phone to operate as the handheld device itself. Both devices may also suffer from insufficient thermal dissipation, as attempting to minimize their bulkiness results in devices that do not have enough surface to dissipate heat. Size and weight may be problems; the glasses may be so large that they are non-ubiquitous, and a user may not want to wear them in public. Users with prescription glasses may further need to now carry two pairs of glasses, their regular prescription glasses and their bulky AR smart glasses.

Importantly, separating some functionality from the smart glasses themselves to the separate handheld device introduces several new problems. As an example, the handheld device is frequently carried in a pocket, purse, or backpack. This affects line of sight (LOS) communications, and further impacts radio frequency (RF) performance, since the antennas in the handheld device may be severely loaded and detuned. Additionally, both units may use field of view (FOV) sensors, which take up significant space and are easily occluded during normal operation. These sensors may require the user to raise their hands in front of the glasses for gesture-controlled commands, which may be odd-looking in public. The use of both glasses and a handheld device further burdens the user, as it requires them to carry so many devices (for example, a cell phone, the handheld device, the AR glasses, and potentially separate prescription glasses), especially since the batteries of the AR glasses and the handheld device often do not last for an entire day, eventually rendering two of the devices the user is carrying useless.

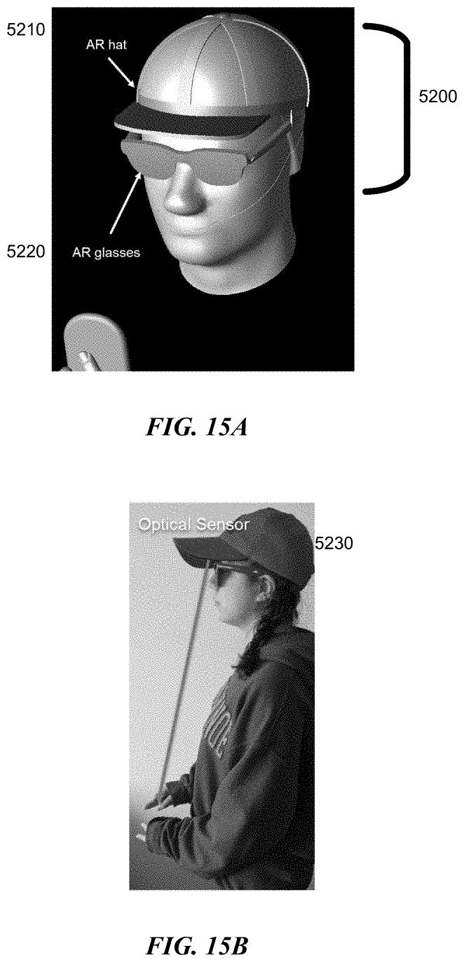

Many of these challenges may be avoided with a more ubiquitous, wearable AR system that mimics common, socially acceptable dress. FIGS. 15A-15B illustrate an example wearable ubiquitous AR system 5200. As illustrated in FIG. 15A, such a wearable ubiquitous mobile communication device may be an AR device including a hat 5210 and a pair of smart glasses 5220. Such an arrangement may be far more ubiquitous; as illustrated in FIG. 15B, a user Veronica Martinez 5230 may wear this AR system 5200 and look very natural. Shifting one or more optical sensors from the AR glasses 5220 to the hat 5210 may also allow the user 5230 to make more discreet user gestures, rather than needing to lift her hands in front of her face to allow sensors on the smart glasses 5220 to detect the gestures. Additionally, connecting a hat to smart glasses allows transferring a significant amount of size and weight away from the glasses and handheld device, so that both of these units are within an acceptable range of ubiquity and functionality. In particular embodiments, use of the hat 5210 may even entirely replace the handheld device, thus enabling the user 5230 to carry one fewer device.

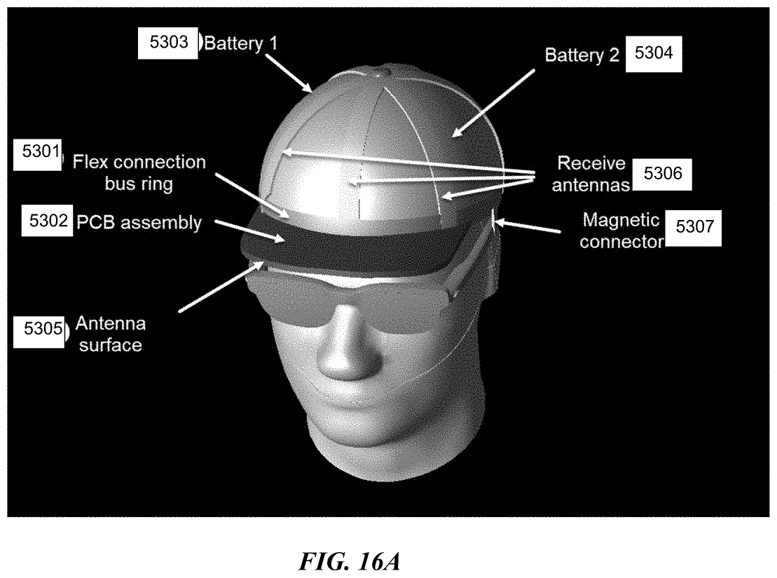

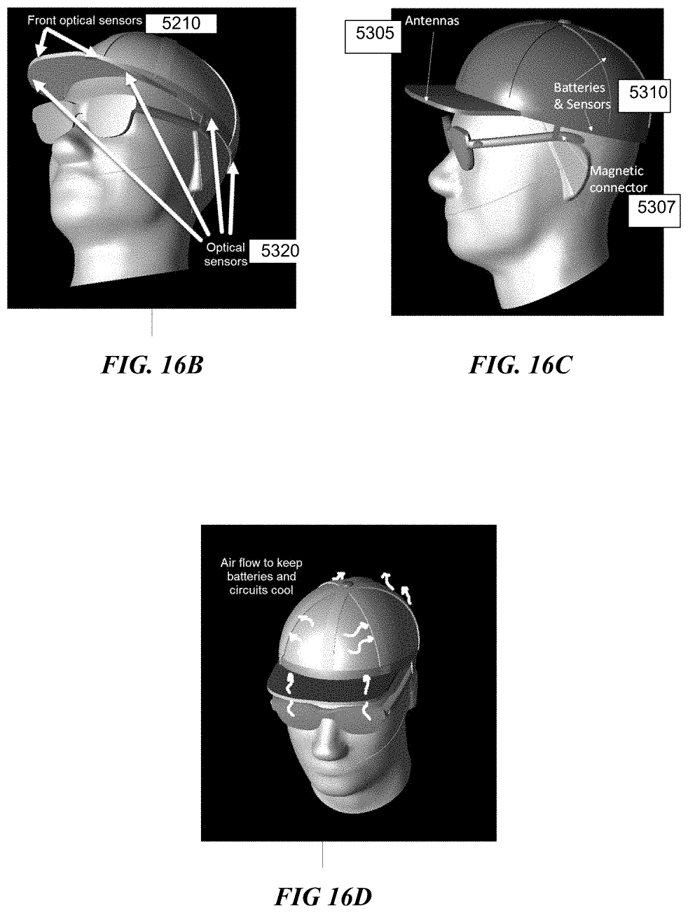

FIG. 16A illustrates various components of the wearable ubiquitous AR system. In particular embodiments, the glasses 5220 may include one or more sensors, such as optical sensors, and one or more displays. Often, these components may be positioned in a frame of the glasses. In some embodiments, the glasses may further include one or more depth sensors positioned in the frame of the glasses. In further embodiments, the hat 5210 may be communicatively coupled to the glasses 5220 and may include various electronics 5301-5307. As an example, hat 5210 may include a data bus ring 5301 positioned around a perimeter of the hat. This flexible connection bus ring 5301 may serve as the backbone of the AR system, carrying signals and providing connectivity to multiple components while interconnecting them to the AR glasses 5220. Hat 5210 may further include a printed circuit board (PCB) assembly 5302 connected to bus ring 5301 hosting multiple ICs, circuits, and subsystems. As examples, PCB 5302 may include IC processors, memory, power control, digital signal processing (DSP) modules, baseband, modems, RF circuits, or antenna contacts. One or more batteries 5303-5304 connected to the data bus ring 5301 may also be included in the hat 5210. In particular embodiments, these batteries may be conformal, providing weight balance and much longer battery life than was previously possible in an AR glasses-only system, or even a system having AR glasses and a handheld device. The hat 5210 may further include one or more TX/RX antennas, such as receive antennas 5306, connected to the data bus ring 5301. In particular embodiments, these antennas may be positioned on antenna surfaces 5305 in a visor of the hat 5210 and/or around the hat 5210, and may provide the means for wireless communications and good RF performance for the AR system 5200.

In particular embodiments, the hat 5210 may also be configured to detachably couple to the pair of glasses 5220, and thus the data bus ring itself is configured to detachably couple to the glasses 5220. As an example, the hat 5210 may include a connector 5307 to connect the AR glasses 5220 to the hat 5210. In particular embodiments, this connector 5307 may be magnetic. When the AR glasses 5220 are physically connected to the hat 5310 by such a connector 5307, wired communication may occur through the connector 5307, rather than relying on wireless connections between the hat 5210 and the glasses 5220. In such an embodiment, this wired connection may reduce the need for several transmitters and may further reduce the amount of battery power consumed by the AR system 5200 over the course of its use. In this embodiment, the glasses may further draw power from the hat, thus reducing, or even eliminating, the number of batteries needed on the glasses themselves.

The hat 5210 may further include various internal and/or external sensors. As an example, one or more inertial measurement unit (IMU) sensors may be connected to the data bus ring 5301 to capture data of user movement and positioning. Such data may include information concerning direction, acceleration, speed, or positioning of the hat 5210, and these sensors may be either internal or external to the hat 5210. Other internal sensors may be used to capture biological signals, such as EMG sensors to detect brain wave signals. In particular embodiments, these brain wave signals may even be used to control the AR system.

The hat 5210 may further include a plurality of external sensors for hand tracking and assessment of a user's surroundings. FIGS. 16B-16D illustrate different views of the wearable ubiquitous AR system 5200. FIG. 16B illustrates several such optical sensors 5320 positioned at the front of and around the perimeter of the hat 5210. In particular embodiments, a plurality of optical sensors connected to the data bus ring 5301 may be positioned in the visor 5305 and/or around the perimeter of the hat 5210. For example, optical sensors, such as cameras or depth sensors, may be positioned at the front, back left, and right of the hat 5210 to capture the environment of the user 5230, while optical sensors for hand tracking may be placed in the front of the hat 5210. However, sensors for depth perception may additionally or alternatively be positioned in the smart glasses 5220, to ensure alignment with projectors in the glasses 5220. In some embodiments, these optical sensors may track user gestures alone; however, in other embodiments, the AR system 5200 may also include a bracelet in wireless communication with the AR system 5200 to track additional user gestures.

FIG. 16C further illustrates a side view of the hat 5210, showing various placements of antennas 5305, batteries and sensors 5310, and the magnetic connector strip 5307. In particular embodiments, as shown in FIG. 16D, in order to keep all these electronics, such as the batteries, sensors, and circuits, cool, the hat 5210 may be made of breathable waterproof or water-resistant material. This permits adequate air flowing systems for additional cooling. Further, the size of the hat 5210 provides a much larger heat dissipation surface than that of the glasses or the handheld unit.

This configuration of an AR system 5200 including smart glasses 5220 and a hat 5210 provides numerous advantages. As an example, offloading much of the electronics of the AR system to the hat 5210 may increase the ubiquity and comfort of the AR system. The weight of the glasses 5220 may be reduced, becoming light and small enough to replace prescription glasses (thus providing some users with one less pair of glasses to carry). Including optical sensors on the visor of the hat may provide privacy to the user Veronica Martinez 5230, as her hands do not need to be lifted in front of the glasses 5220 during gestures in order to be captured by the sensors of the AR system. Rather, user gestures may be performed and concealed close to the body in a natural position.

As another example, positioning TX/RX antennas at the edge of the visor may provide sufficient distance and isolation from the user's body and head for maximum performance and protection from RF radiation. These antennas may not be loaded or detuned by body parts, and the fixed distance from the head may eliminate Specific Absorption Rate (SAR) concerns, since the visor may be further from the body than a cell phone during normal usage. Often, handheld devices and wearables like smart watches suffer substantial RF performance reductions due to head, hand, arm, or body occlusion or loading; however, by placing the antennas at the edge of the visor, they may not be loaded by any body parts. Also, enabling the direct, wired connection of the smart glasses 5220 to the hat 5210 through the connector 5307 may eliminate the need for LOS communications, as is required when smart glasses communicate with a handheld unit that may be carried in a pocket or purse. Placing GPS and cellular antennas on a hat rather than an occluded handheld device may result in reduced power consumption and increased battery life, and thermal dissipation for these antennas may not be as great a problem.

Even the hat 5210 itself provides many advantages. As an example, the simple size and volume of the hat 5210 may allow plenty of surface area for thermal dissipation. The position of the hat close to the user's head may allow for new sensors (such as EMG sensors) to be integrated into and seamlessly interact with the AR system. Further, the visor may provide natural shadow to the solar glare that often affects optical sensors mounted on the glasses 5220. And when the hat 5210 is removed, the AR system 5200 may be disabled, thus providing the user 5230 and people around the user with an easily controllable and verifiable indication of when the AR system 5200 is operating and detecting their surroundings and biological data. In this case, the AR glasses 5220 may no longer collect or transmit images or sounds surrounding the user 5230 even if the user 5230 continues to wear them (e.g., as prescription glasses), thus reassuring her privacy. This disabling of the AR system by removing the hat may also provide an easily verifiable sign to those around the user 5230 that the user's AR system is no longer collecting images or sounds of them.

### Systems and Methods

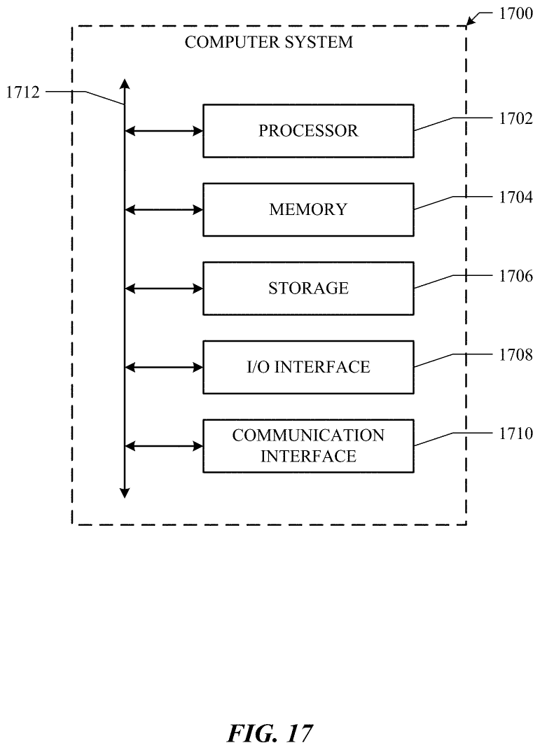

FIG. 17 illustrates an example computer system 1700. In particular embodiments, one or more computer systems 1700 perform one or more steps of one or more methods described or illustrated herein. In particular embodiments, one or more computer systems 1700 provide functionality described or illustrated herein. In particular embodiments, software running on one or more computer systems 1700 performs one or more steps of one or more methods described or illustrated herein or provides functionality described or illustrated herein. Particular embodiments include one or more portions of one or more computer systems 1700. Herein, reference to a computer system may encompass a computing device, and vice versa, where appropriate. Moreover, reference to a computer system may encompass one or more computer systems, where appropriate.

This disclosure contemplates any suitable number of computer systems 1700. This disclosure contemplates computer system 1700 taking any suitable physical form. As example and not by way of limitation, computer system 1700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1700 may include one or more computer systems 1700; be unitary or distributed; span multiple locations; span multiple machines; span multiple data centers; or reside in a cloud, which may include one or more cloud components in one or more networks. Where appropriate, one or more computer systems 1700 may perform without substantial spatial or temporal limitation one or more steps of one or more methods described or illustrated herein. As an example and not by way of limitation, one or more computer systems 1700 may perform in real time or in batch mode one or more steps of one or more methods described or illustrated herein. One or more computer systems 1700 may perform at different times or at different locations one or more steps of one or more methods described or illustrated herein, where appropriate.

In particular embodiments, computer system 1700 includes a processor 1702, memory 1704, storage 1706, an input/output (I/O) interface 1708, a communication interface 1710, and a bus 1712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1702 includes hardware for executing instructions, such as those making up a computer program. As an example and not by way of limitation, to execute instructions, processor 1702 may retrieve (or fetch) the instructions from an internal register, an internal cache, memory 1704, or storage 1706; decode and execute them; and then write one or more results to an internal register, an internal cache, memory 1704, or storage 1706. In particular embodiments, processor 1702 may include one or more internal caches for data, instructions, or addresses. This disclosure contemplates processor 1702 including any suitable number of any suitable internal caches, where appropriate. As an example and not by way of limitation, processor 1702 may include one or more instruction caches, one or more data caches, and one or more translation lookaside buffers (TLBs). Instructions in the instruction caches may be copies of instructions in memory 1704 or storage 1706, and the instruction caches may speed up retrieval of those instructions by processor 1702. Data in the data caches may be copies of data in memory 1704 or storage 1706 for instructions executing at processor 1702 to operate on; the results of previous instructions executed at processor 1702 for access by subsequent instructions executing at processor 1702 or for writing to memory 1704 or storage 1706; or other suitable data. The data caches may speed up read or write operations by processor 1702. The TLBs may speed up virtual-address translation for processor 1702. In particular embodiments, processor 1702 may include one or more internal registers for data, instructions, or addresses. This disclosure contemplates processor 1702 including any suitable number of any suitable internal registers, where appropriate. Where appropriate, processor 1702 may include one or more arithmetic logic units (ALUs); be a multi-core processor; or include one or more processors 1702. Although this disclosure describes and illustrates a particular processor, this disclosure contemplates any suitable processor.

In particular embodiments, memory 1704 includes main memory for storing instructions for processor 1702 to execute or data for processor 1702 to operate on. As an example and not by way of limitation, computer system 1700 may load instructions from storage 1706 or another source (such as, for example, another computer system 1700) to memory 1704. Processor 1702 may then load the instructions from memory 1704 to an internal register or internal cache. To execute the instructions, processor 1702 may retrieve the instructions from the internal register or internal cache and decode them. During or after execution of the instructions, processor 1702 may write one or more results (which may be intermediate or final results) to the internal register or internal cache. Processor 1702 may then write one or more of those results to memory 1704. In particular embodiments, processor 1702 executes only instructions in one or more internal registers or internal caches or in memory 1704 (as opposed to storage 1706 or elsewhere) and operates only on data in one or more internal registers or internal caches or in memory 1704 (as opposed to storage 1706 or elsewhere). One or more memory buses (which may each include an address bus and a data bus) may couple processor 1702 to memory 1704. Bus 1712 may include one or more memory buses, as described below. In particular embodiments, one or more memory management units (MMUs) reside between processor 1702 and memory 1704 and facilitate accesses to memory 1704 requested by processor 1702. In particular embodiments, memory 1704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1704 may include one or more memories 1704, where appropriate. Although this disclosure describes and illustrates particular memory, this disclosure contemplates any suitable memory.

In particular embodiments, storage 1706 includes mass storage for data or instructions. As an example and not by way of limitation, storage 1706 may include a hard disk drive (HDD), a floppy disk drive, flash memory, an optical disc, a magneto-optical disc, magnetic tape, or a Universal Serial Bus (USB) drive or a combination of two or more of these. Storage 1706 may include removable or non-removable (or fixed) media, where appropriate. Storage 1706 may be internal or external to computer system 1700, where appropriate. In particular embodiments, storage 1706 is non-volatile, solid-state memory. In particular embodiments, storage 1706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1706 taking any suitable physical form. Storage 1706 may include one or more storage control units facilitating communication between processor 1702 and storage 1706, where appropriate. Where appropriate, storage 1706 may include one or more storages 1706. Although this disclosure describes and illustrates particular storage, this disclosure contemplates any suitable storage.

In particular embodiments, I/O interface 1708 includes hardware, software, or both, providing one or more interfaces for communication between computer system 1700 and one or more I/O devices. Computer system 1700 may include one or more of these I/O devices, where appropriate. One or more of these I/O devices may enable communication between a person and computer system 1700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1708 for them. Where appropriate, I/O interface 1708 may include one or more device or software drivers enabling processor 1702 to drive one or more of these I/O devices. I/O interface 1708 may include one or more I/O interfaces 1708, where appropriate. Although this disclosure describes and illustrates a particular I/O interface, this disclosure contemplates any suitable I/O interface.

In particular embodiments, communication interface 1710 includes hardware, software, or both providing one or more interfaces for communication (such as, for example, packet-based communication) between computer system 1700 and one or more other computer systems 1700 or one or more networks. As an example and not by way of limitation, communication interface 1710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1710 for it. As an example and not by way of limitation, computer system 1700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1700 may include any suitable communication interface 1710 for any of these networks, where appropriate. Communication interface 1710 may include one or more communication interfaces 1710, where appropriate. Although this disclosure describes and illustrates a particular communication interface, this disclosure contemplates any suitable communication interface.

In particular embodiments, bus 1712 includes hardware, software, or both coupling components of computer system 1700 to each other. As an example and not by way of limitation, bus 1712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1712 may include one or more buses 1712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing device:
accessing low-resolution observations for a geographic area and corresponding camera poses associate with the low-resolution observations, and a low-resolution map for the geographic area;
generating one or more high-resolution representations of one or more objects by processing the set of low-resolution observations for the geographic area, the corresponding camera poses associated with the set of low-resolution observations, and the low-resolution map for the geographic area using a machine-learning model;
combining the one or more high-resolution representations of one or more objects that are identified in the low-resolution observations; and
creating a high-resolution three-dimensional scene by performing a scene level optimization on the combined representations.

2. An augmented reality (AR) device comprising:
a pair of glasses, wherein the glasses comprise one or more sensors and one or more displays; and
a hat comprising:
a data bus ring positioned around a perimeter of the hat and configured to detachably couple to the pair of glasses,
one or more TX/RX antennas positioned in a visor of the hat and connected to the data bus ring,
one or more batteries connected to the data bus ring, and
a plurality of optical sensors positioned in the visor and around the perimeter of the hat and connected to the data bus ring.

3. An artificial reality system comprising:
one or more cameras capturing images or videos of environments;
a display;
one or more processors; and
a non-transitory memory coupled to the processors comprising instructions executable by the processors.

4. The artificial reality system of claim 3, wherein the processors are operable when executing the instructions to:
receive user signals from the user;
determine a user intention based on the received signals;
construct one or more first commands for a user device based on the determined user intention, wherein the one or more first commands are to be executed by the user device to fulfill the determined user intention; and
send one of the one or more first commands to the user device.

5. The artificial reality system of claim 3, wherein the processors are operable when executing the instructions to:
access a first frame of a video stream captured by one of the one or more cameras;
compute bearing vectors corresponding to tracked features in the first frame;
compute a rotation and an unscaled translation of the camera corresponding to the first frame with respect to a second frame, wherein the second frame is a previous keyframe, and wherein the previous keyframe is determined based on heuristics;
determine a scaled translation of the camera corresponding to the first frame with respect to the second frame by computing a scale of the translation; and
send, to a module utilizing a pose information, the rotation and the scaled translation of the camera corresponding to the first frame with respect to the second frame.

6. The artificial reality system of claim 3, wherein the processors are operable when executing the instructions to:
run an application;
receive a command to have content from the application displayed on a second computing device, wherein the artificial reality system and the second computing device are connected over a short-range wireless connection;
generate rendering instructions for rendering visual content of the application; and
send the rendering instructions to the second computing device, wherein the rendering instructions are configured to cause the second computing device to render and display the visual content of the application on a display.
